(19) United States
(12) Patent Application Publication
(10) Pub. No.: US 2026/0094031 A1
(43) Pub. Date: Apr. 2, 2026

(54) CAUSE ESTIMATION METHOD AND INFORMATION PROCESSING APPARATUS

(71) Applicant: Fujitsu Limited, Kawasaki-shi (JP)

(72) Inventors: Yoshihiro OKAWA, Yokohama (JP); Tatsuya KIKUZUKI, Kawasaki (JP); Masatoshi OGAWA, Zama (JP)

(73) Assignee: Fujitsu Limited, Kawasaki-shi (JP)

(21) Appl. No.: 19/336,986

(22) Filed: Sep. 23, 2025

(30) Foreign Application Priority Data
Sep. 27, 2024 (JP) 2024-168157

(51) Int. Cl. G06N 5/04; G06N 5/025

(52) U.S. Cl. CPC G06N 5/041; G06N 5/025

(57) ABSTRACT

An information processing apparatus selects, out of nodes in a knowledge graph, a first node that is similar to a first phenomenon whose cause is to be estimated. The information processing apparatus generates a sub-knowledge graph including the first node and a second node by tracing from the first node as a starting point to the second node at an end on a cause side of a causal relationship. The information processing apparatus determines a confidence level of the sub-knowledge graph based on a similarity of a first node included in the sub-knowledge graph to a first phenomenon. The information processing apparatus then determines whether to include a third phenomenon indicated by the second node in the sub-knowledge graph in cause candidates of the first phenomenon based on the confidence level of the sub-knowledge graph.

### CROSS-REFERENCE TO RELATED APPLICATION

This application is based upon and claims the benefit of priority of the prior Japanese Patent Application No. 2024-168157, filed on Sep. 27, 2024, the entire contents of which are incorporated herein by reference.

### FIELD

The embodiments discussed herein relate to a cause estimation method and an information processing apparatus.

### BACKGROUND

Inference technologies that use computers generate an answer to a question by referring to a plurality of documents. It is possible to represent the knowledge indicated by a plurality of documents with a knowledge graph, for example. A knowledge graph systematically connects various pieces of knowledge which are represented in a graph structure.

One example of a proposed technique that relates to inferring information estimates a problem graph based on patterns over time found from state change data in the past, with no need to prepare heuristic rules. A method for generating knowledge graphs and sub-graph clusters for analyzing root causes has also been proposed. A knowledge graph embedded representation method for implementing a semantic expansion of entities, improving the ability to represent complex relationships between entities in a knowledge graph, and improving the accuracy and comprehensiveness of knowledge graph completion has also been proposed. An apparatus for training a knowledge graph embedding model of ontology-enhanced knowledge graphs has also been proposed. In addition, a technique for inferring a causal relationship of a failure in a microservice incapable of collecting trace data has also been proposed. See, for example, the following literature.
Japanese National Publication of International Patent Application No. 2024-517562

### U.S. Patent Application Publication No. 2023/0050889

U.S. Patent Application Publication No. 2022/0121966
Japanese Laid-open Patent Publication No. 2023-4969
International Publication Pamphlet No. WO 2024-142312

### SUMMARY

In one aspect, there is provided a cause estimation method including: receiving, by a processor, an input of a sentence indicating a first phenomenon whose cause is to be estimated; selecting, by the processor, one or a plurality of first nodes indicating a second phenomenon that is similar to the first phenomenon, out of a plurality of nodes in a knowledge graph including the plurality of nodes which indicate a plurality of phenomena and edges indicating causal relationships between the plurality of phenomena; generating, by the processor, a sub-knowledge graph including a first node and a second node by tracing from the first node as a starting point to the second node at an end on a cause side of the causal relationship indicated by an edge; determining, by the processor, a confidence level that a third phenomenon indicated by the second node included in the sub-knowledge graph is a cause of the first phenomenon based on a similarity of the first node included in the sub-knowledge graph to the first phenomenon; and determining, by the processor and based on the confidence level of the sub-knowledge graph, whether to include the third phenomenon indicated by the second node included in the sub-knowledge graph in cause candidates of the first phenomenon.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 depicts one example of a cause estimation method according to a first embodiment;

FIG. 2 depicts an example system configuration according to a second embodiment;

FIG. 3 depicts example hardware of a server;

FIG. 4 depicts an example of failure cause estimation in an IT system;

FIG. 5 depicts an example of failure cause estimation using an LLM;

FIG. 6 depicts examples of KG inference;

FIG. 7 depicts one example of failure cause estimation using a causal relationship KG;

FIG. 8 is a block diagram depicting a function for estimating the cause of a failure at a server;

FIG. 9 depicts one example of a causal relationship KG;

FIG. 10 is (a first part of) a flowchart depicting an example procedure of KG inference processing;

FIG. 11 depicts one example of division processing for an input query;

FIG. 12 depicts examples of sub-queries obtained by decomposing an input query;

FIG. 13 depicts an example calculation method of similarity;

FIG. 14 depicts one example of a similar entity selection result;

FIG. 15 is (a second part of) a flowchart depicting an example procedure of KG inference processing;

FIG. 16 depicts an example process of generating a path with a similar entity as a starting point;

FIG. 17 depicts one example of a subKG extraction method;

FIG. 18 depicts an example calculation of a confidence score for each subKG;

FIG. 19 depicts an example method of calculating a confidence score;

FIG. 20 depicts one example of a failure cause estimation result;

FIG. 21 depicts one example of an answer display screen;

FIG. 22 depicts an example of generation processing of an estimation result of a failure cause;

FIG. 23 depicts an example display content of a detailed information display section for a failure cause candidate;

FIG. 24 depicts one example of a confidence score calculation basis screen;

FIG. 25 depicts an example method of correcting a confidence score; and

FIG. 26 depicts an example correction result of a confidence score.

### DESCRIPTION OF EMBODIMENTS

In the related art in which an answer to a question is inferred by referring to a plurality of documents, the documents are only referred to individually. This means that causal relationships between various phenomena, such as failures, are unclear and the estimation accuracy for the cause of a phenomenon is insufficient.

Several embodiments will now be described with reference to the accompanying drawings. Note that the respective embodiments may be implemented in combination within a range that is technically consistent.

### First Embodiment

The first embodiment is a cause estimation method capable of improving the estimation accuracy of the cause of a phenomenon. When estimating the cause of a failure, the “phenomenon” referred to here may include a failure that has occurred, the cause of the failure, and other phenomena aside from the failure and its cause.

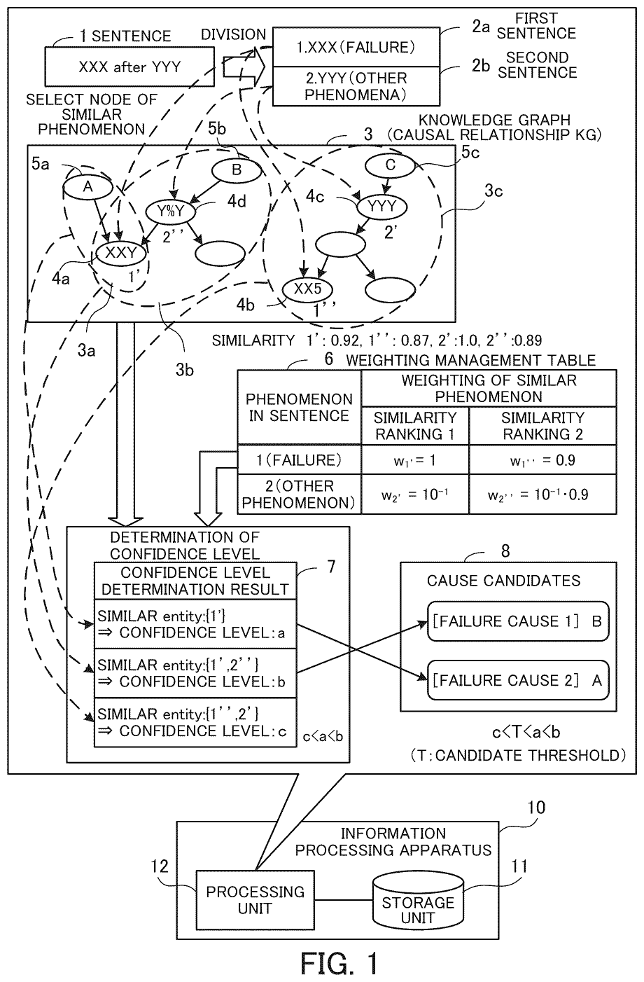

FIG. 1 depicts one example of a cause estimation method according to the first embodiment. In FIG. 1, an information processing apparatus 10 for implementing this cause estimation method is depicted. As one example, the information processing apparatus 10 may implement the cause estimation method by executing a cause estimation program.

The information processing apparatus 10 includes a storage unit 11 and a processing unit 12. As examples, the storage unit 11 is a memory or a storage apparatus included in the information processing apparatus 10. The processing unit 12 is a processor included in the information processing apparatus 10, for example. The information processing apparatus 10 may include a plurality of processors. A processor that executes a particular process out of a plurality of processes executed by the information processing apparatus 10 may differ from processors that execute processes aside from that particular process.

The storage unit 11 stores a cause estimation program, for example. The storage unit 11 stores a knowledge graph 3 prepared in advance. The knowledge graph 3 includes a plurality of nodes indicating a plurality of phenomena and edges indicating causal relationships between the plurality of phenomena. Each edge indicating a causal relationship is, for example, an arrow from a node indicating a phenomenon corresponding to the cause in the causal relationship to a node indicating a phenomenon corresponding to the result of the causal relationship. This knowledge graph 3 may also be referred to as a “causal knowledge graph” since it represents causal relationships between phenomena.

As one example, the processing unit 12 executes the cause estimation method in accordance with a processing procedure indicated by the cause estimation program. The processing procedure of the cause estimation method executed by the processing unit 12 is as described below.

The processing unit 12 receives an input of a sentence 1 indicating a first phenomenon whose cause is to be estimated. As one example, sentence 1 is a natural language description of a fault that has occurred in a computer system. The input sentence 1 may include descriptions relating to a plurality of phenomena. For this reason, the processing unit 12 may divide the inputted sentence 1 into a separate sentence for each phenomenon. As one example, the processing unit 12 divides the sentence 1 indicating a first phenomenon into a first sentence 2a indicating a phenomenon that has appeared as a failure and a second sentence 2b indicating a phenomenon that has occurred due to the failure.

In the example in FIG. 1, “XXX after YYY” is written in the sentence 1. This indicates that the phenomenon “XXX” appeared after the phenomenon “YYY”. When the sentence 1 is a description relating to a failure, “XXX” is a description indicating the failure, and “YYY” is a description indicating a phenomenon aside from the failure. In this case, the processing unit 12 divides the sentence 1 into a first sentence 2a with the description “XXX” indicating the phenomenon of the failure and a second sentence 2b of the description “YYY” indicating the phenomenon aside from the failure.

Out of a plurality of nodes in the knowledge graph 3, the processing unit 12 selects one or a plurality of first nodes 4a to 4d indicating a second phenomenon that is similar to the first phenomenon. When the sentence 1 has been divided into the first sentence 2a and the second sentence 2b, the processing unit 12 selects a node representing a phenomenon that is similar to the first sentence 2a and a node representing a phenomenon that is similar to the second sentence 2b as the first nodes 4a to 4d.

In the example in FIG. 1, the similarity of the first node 4a to the first sentence 2a is “0.92”. The similarity of the first node 4b to the first sentence 2a is “0.87”. The similarity of the first node 4c to the second sentence 2b is “1.0”. The similarity of the first node 4d to the second sentence 2b is “0.89”. For this reason, the first nodes 4a and 4b are selected as being similar to the first sentence 2a, and the first nodes 4c and 4d are selected as being similar to the second sentence 2b.

The processing unit 12 generates sub-knowledge graphs 3a to 3c including the first nodes 4a to 4d and second nodes 5a to 5c by tracing edges from the first nodes 4a to 4d as starting points to the second nodes 5a to 5c that are terminal ends on the cause-sides of causal relationships indicated by the edges. The sub-knowledge graphs 3a to 3c also include nodes that are passed when tracing the causal relationships. As one example, the sub-knowledge graph 3a is generated by tracing a causal relationship from the first node 4a as a starting point to the second node 5a at the terminal end. The sub-knowledge graph 3b is generated by tracing a causal relationship from the first node 4a as a starting point to the second node 5b at the terminal end. The sub-knowledge graph 3c is generated by tracing a causal relationship from the first node 4b as a starting point to the second node 5c at the terminal end. Although not depicted in FIG. 1, sub-knowledge graphs with the first nodes 4c and 4d as starting points may also be generated.

The processing unit 12 determines a confidence level that third phenomena indicated by the second nodes 5a to 5c included in the sub-knowledge graphs 3a to 3c are the cause of the first phenomenon. As one example, the processing unit 12 determines the confidence level based on the similarity to the first nodes 4a to 4d included in the sub-knowledge graphs 3a to 3c to the first phenomenon. In this case, for the processing unit 12, the higher the similarity of the first nodes 4a to 4d included in the sub-knowledge graphs 3a to 3c, the higher the confidence level of the sub-knowledge graphs 3a to 3c. By doing so, a confidence level determination result 7 indicating the confidence levels of the sub-knowledge graphs 3a to 3c is obtained.

The sub-knowledge graph 3b includes a plurality of first nodes 4a and 4d. The sub-knowledge graph 3c also includes a plurality of first nodes 4b and 4c. The confidence levels of the sub-knowledge graphs 3b and 3c, which include a plurality of first nodes, are higher than the confidence levels of the sub-knowledge graphs 3b and 3c that include only one of the first nodes.

The processing unit 12 may set a similarity weighting to each of the first nodes 4a to 4d. As one example, the processing unit 12 includes a weighting management table 6. In the weighting management table 6, the weighting of a node that is similar to a sentence is set according to whether the phenomenon indicated by that sentence is a failure or not a failure. As one example, the similarity weighting of a node of a phenomenon that is similar to a sentence indicating a failure is higher than the weighting similarity of a node of a phenomenon that is similar to a sentence indicating a phenomenon aside from a failure.

In the weighting management table 6, weightings of the first nodes 4a to 4d are set in descending order of similarity to a sentence indicating a phenomenon (the sentence 1, the first sentence 2a, or the second sentence 2b). In this case, the smaller the value indicating a ranking based on similarity, the higher the weighting.

When weightings are used, the processing unit 12 determines the confidence levels of the sub-knowledge graphs 3a to 3c based on the similarity of the first nodes 4a to 4d and the weightings of the first nodes 4a to 4d. As one example, the processing unit 12 calculates a weighted sum of the similarities of the first nodes 4a to 4d included in each of the sub-knowledge graphs 3a to 3c, and sets the confidence level at a higher value as the calculation result increases.

In the example in FIG. 1, the sub-knowledge graph 3a includes the first node 4a, and the sub-knowledge graph 3b includes the first node 4a and the first node 4d. In this case, the confidence level “b” of the sub-knowledge graph 3b is higher than the confidence level “a” of the sub-knowledge graph 3a by an amount corresponding to the inclusion of the first node 4d.

The sub-knowledge graph 3c includes the first node 4b that is similar to a failure and the first node 4c that is similar to a phenomenon aside from a failure. The similarity ranking of the first node 4b that is similar to the first sentence 2a that indicates the failure is second.

For this reason, the confidence level “c” of the sub-knowledge graph 3c is smaller than the confidence levels “a, b” of the sub-knowledge graphs 3a, 3b including the first node 4a that is most similar to the first sentence 2a indicating a failure.

The processing unit 12 determines, based on the confidence levels of the sub-knowledge graphs 3a to 3c, whether to include third phenomena indicated by the second nodes 5a to 5c of the sub-knowledge graphs 3a to 3c in cause candidates 8 of the first phenomenon. As one example, the processing unit 12 compares the confidence levels of the sub-knowledge graphs 3a to 3c with a candidate threshold “T” that is set in advance. The processing unit 12 determines that a third phenomenon corresponding to a sub-knowledge graph whose confidence level is larger than the candidate threshold “T” is to be included in the cause candidates 8.

In the example in FIG. 1, the confidence levels “a” and “b” of the sub-knowledge graphs 3a and 3b are larger than the candidate threshold “T”, but the confidence level “c” of the sub-knowledge graph 3c is smaller than the candidate threshold “T”. For this reason, in the cause candidates 8, the phenomenon “A” indicated by the second node 5a included in the sub-knowledge graph 3a and the phenomenon “B” indicated by the second node 5b included in the sub-knowledge graph 3b are indicated as failure causes.

In this way, the processing unit 12 may obtain a candidate for another phenomenon that is a cause of the phenomenon indicated in the inputted sentence 1 using the knowledge graph 3, which is a causal relationship KG. As one example, by generating the knowledge graph 3 based on correct knowledge of the past, accurate causal relationships between phenomena will be correctly represented by the knowledge graph 3. This means that by estimating the cause of a phenomenon based on the knowledge graph 3, the processing unit 12 is capable of estimating the cause of the phenomenon with high accuracy. In addition, since the knowledge graph 3 representing accurate causal relationships between phenomena is used, the occurrence of hallucinations is suppressed.

Estimation of the cause of a phenomenon like this may be used to estimate the cause of a system failure in a computer system, for example. As one example, the knowledge graph 3 indicating causal relationships between the causes and the results of failures may be created based on information such as a response history to failures in a system, such as a computer system. The processing unit 12 may use such knowledge graph 3 to estimate the cause of a failure and thereby obtain appropriate candidates for the cause of the failure.

The processing unit 12 may divide the sentence 1 into a first sentence 2a indicating a failure and a second sentence 2b indicating a phenomenon that has occurred due to the failure. By doing so, even when a plurality of phenomena are described in the sentence 1, it is possible to infer the cause with high accuracy by considering each of the phenomena.

As one example, the processing unit 12 may set different weightings to the first nodes 4a and 4b that are similar to the first sentence 2a indicating a failure and the first nodes 4c and 4d that are similar to the second sentence 2b indicating a phenomenon aside from a failure. Phenomena aside from a failure include a phenomenon that are hardly related to the root cause of the failure. This means the processing unit 12 is capable of improving the accuracy of confidence levels by increasing the weightings of the similarities of the first nodes 4a to 4d that are similar to the failure.

The processing unit 12 may also set the similarity weightings based on rankings of similarity. As one example, a higher weighting is set for a first node with a higher similarity ranking to the first sentence 2a or the second sentence 2b. By doing so, the accuracy when calculating confidence levels is improved.

Note that the processing unit 12 may also include, in the sub-knowledge graphs 3a to 3c, nodes on paths traced from a first node as a starting point to a second node as an end point and nodes reachable by tracing a predetermined causal relationship from a node on a path. As one example, when a phenomenon of a node on a path that has already been traced has occurred, the processing unit 12 includes a node corresponding to another phenomenon that occurs at the same time as the phenomenon of the node already on the path in a sub-knowledge graph. The processing unit 12 may include, in a sub-knowledge graph, a node indicating a log of when a phenomenon of a node on a path that has already been traced occurred. By expanding the sub-knowledge graph in this way, the processing unit 12 may comprehensively include information on phenomena relating to a failure that has occurred in any of the sub-knowledge graphs 3a to 3c. As a result, the calculation accuracy for confidence levels is improved.

When outputting cause candidates 8, the processing unit 12 may output the cause candidates 8, which are information indicating the causes determined for inclusion, arranged in order of their confidence levels. In the example in FIG. 1, the confidence level “b” of the sub-knowledge graph 3b is higher than the confidence level “a” of the sub-knowledge graph 3a. For this reason, in the cause candidates 8, the processing unit 12 places the phenomenon “B”, which is indicated by the second node 5b included in the sub-knowledge graph 3b, at a higher position, and places the phenomenon “A”, which is indicated by the second node 5a included in the sub-knowledge graph 3a, at a lower position. By doing so, when for example a large number of candidates for the cause of a failure have been obtained, the user is able to check the content of the cause candidates of a failure in descending order of confidence level, which makes the task of identifying the cause of the failure more efficient.

In addition, the processing unit 12 may output information relating to the phenomena indicated by respective nodes included in the sub-knowledge graphs 3a and 3b including the second nodes 5a and 5b corresponding to causes determined for inclusion in the cause candidates 8 together with information indicating the causes. This makes it possible for example for the user to know a confirmation procedure for confirming whether a failure cause indicated as an answer to a query has actually occurred. In addition, the user may obtain information on what kind of path a failure occurred from the failure cause indicated as an answer to a query. As a result, the user is able to efficiently identify the cause of a failure.

Note that the processing unit 12 may correct the confidence levels of the sub-knowledge graphs 3a to 3c based on information used for generating the knowledge graph 3 using a trained language model (for example, a large language model (LLM)). The information used to generate the knowledge graph 3 includes knowledge that is not included in the knowledge graph 3. By using a language model, the confidence levels of the sub-knowledge graphs 3a to 3c are corrected so as to not be inconsistent with the knowledge of the information used to generate the knowledge graph 3, for example. As a result, the accuracy of the confidence levels is improved.

### Second Embodiment

The second embodiment is a computer system that uses a knowledge graph to realize highly accurate estimation of a failure cause in an information technology (IT) system.

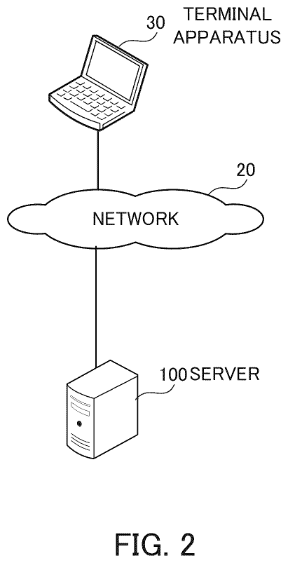

FIG. 2 depicts an example system configuration according to the second embodiment. A server 100 and a terminal apparatus 30 are connected via a network 20. The server 100 is a computer that estimates a failure cause. The terminal apparatus 30 is a computer used by a user who requests estimation of a failure cause.

As one example, the server 100 includes a causal relationship KG where causal relationships of failures are represented by a knowledge graph (hereinafter, “KG”). When the server 100 has acquired a query indicating the content of a failure that has occurred from the terminal apparatus 30, the server 100 uses the causal relationship KG to estimate the failure cause based on the query.

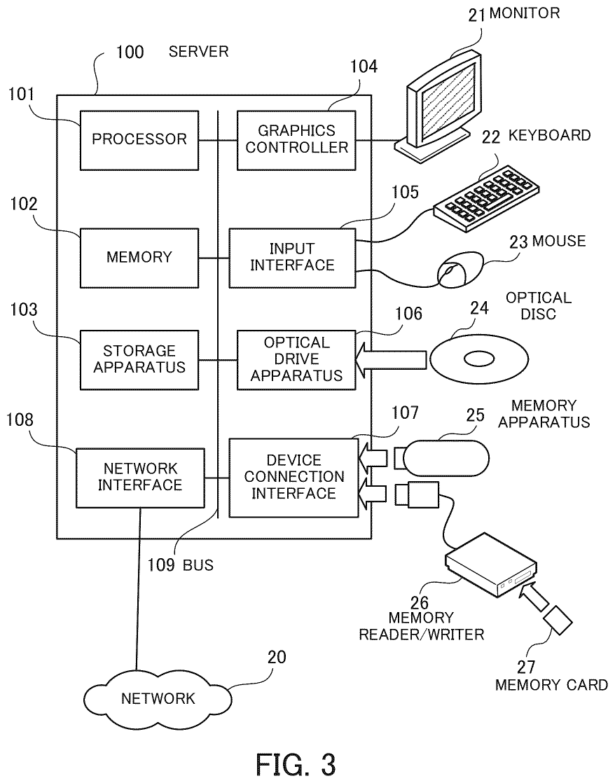

FIG. 3 depicts example hardware of a server. The server 100 as a whole is controlled by a processor 101. A memory 102 and a plurality of peripheral devices are connected to the processor 101 via a bus 109.

The server 100 may be a multiprocessor system including a plurality of processors. A group of processors in a multiprocessor system may be referred to as “the processor 101”. The processor 101 may also be referred to as “processor circuitry”. Each processor in the plurality of processors may execute some or all of the plurality of processes executed by the server 100. When there are a plurality of related processes, a processor that executes a certain process out of the plurality of processors may differ from processors that executes processes aside from that certain process.

As examples, the processor 101 is a central processing unit (CPU), a micro processing unit (MPU), or a digital signal processor (DSP). At least some of the functions realized by the processor 101 executing a program may be realized by an electronic circuit, such as an application integrated circuit (ASIC) or a programmable logic device (PLD).

The memory 102 is used as a main storage apparatus of the server 100. The memory 102 temporarily stores at least part of an operating system (OS) program and application programs to be executed by the processor 101. The memory 102 also stores various data used in processing by the processor 101. As an example of the memory 102, a volatile semiconductor storage apparatus such as random access memory (RAM) is used.

The peripheral devices connected to the bus 109 include a storage apparatus 103, a graphics controller 104, an input interface 105, an optical drive apparatus 106, a device connection interface 107, and a network interface 108.

The storage apparatus 103 electrically or magnetically writes and reads data to and from a built-in recording medium. The storage apparatus 103 is used as an auxiliary storage apparatus of the server 100. The storage apparatus 103 stores an OS program, application programs, and various data. As examples of the storage apparatus 103, a hard disk drive (HDD) or a solid state drive (SSD) may be used.

The graphics controller 104 is a computational apparatus that performs image processing. As one example, the graphics controller 104 is a graphics processing unit (GPU). A monitor 21 is connected to the graphics controller 104. The graphics controller 104 displays images on a screen of the monitor 21 in accordance with instructions from the processor 101. Examples of the monitor 21 include a display apparatus that uses organic electroluminescence (EL) and a liquid crystal display apparatus. When, for example, a GPU is used as the graphics controller 104, the graphics controller 104 may execute complex numerical calculations, such as matrix calculations.

A keyboard 22 and a mouse 23 are connected to the input interface 105. The input interface 105 transmits signals sent from the keyboard 22 and the mouse 23 to the processor 101. Note that the mouse 23 is one example of a pointing device, and other pointing devices may be used. Examples of other pointing devices include a touch panel, a tablet, a touch pad, and a track ball.

The optical drive apparatus 106 uses laser light or the like to read data recorded on an optical disc 24 or to write data onto the optical disc 24. The optical disc 24 is a portable recording medium on which data is recorded so as to be readable by reflection of light. The optical disc 24 may be a digital versatile disc (DVD), a DVD-RAM, a compact disc read only memory (CD-ROM), a CD-recordable (CD-R), a CD-rewritable (CD-RW), or the like.

The device connection interface 107 is a communication interface for connecting peripheral devices to the server 100. As examples, a memory apparatus 25 and a memory reader/writer 26 may be connected to the device connection interface 107. The memory apparatus 25 is a recording medium with a function of communicating with the device connection interface 107. The memory reader/writer 26 is an apparatus that writes data onto a memory card 27 or reads data from the memory card 27. The memory card 27 is a card-type recording medium.

The network interface 108 is connected to the network 20. The network interface 108 transmits and receives data to and from other computers or communication devices via the network 20. The network interface 108 is a wired communication interface connected via a cable to a wired communication apparatus, such as a switch or a router. The network interface 108 may be a wireless communication interface connected so as to communicate using radio waves with a wireless communication apparatus, such as a base station or an access point.

The server 100 realizes the processing functions of the second embodiment using hardware like that described above. Note that the information processing apparatus 10 described in the first embodiment may also be implemented by similar hardware to the server 100 depicted in FIG. 3.

The server 100 realizes the processing functions of the second embodiment by executing a program recorded on a computer-readable recording medium, for example. A program in which the processing content to be executed by the server 100 is written may be recorded on various recording media. As one example, a program to be executed by the server 100 may be stored in the storage apparatus 103. The processor 101 loads at least part of the program in the storage apparatus 103 into the memory 102 and executes the program. The program to be executed by the server 100 may be recorded on a portable recording medium, such as the optical disc 24, the memory apparatus 25, or the memory card 27. As one example, the program stored in the portable recording medium becomes executable after being installed into the storage apparatus 103 under the control of the processor 101. Alternatively, the processor 101 may read the program directly from the portable recording medium and execute the program.

Here, the importance and difficulty of estimating the cause of a failure in an IT system will be described. To operate an IT system or a network stably, it is important to have a failure cause estimation technique capable of speeding up recovery from failures. In recent years in particular, system configurations have become complex due to virtualization and multi-vendor handling, resulting in increasingly diverse causes of failures. This makes it increasingly difficult to estimate the cause of a failure with high accuracy.

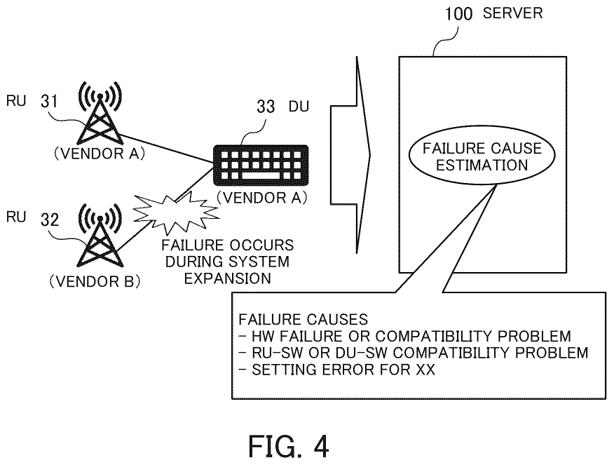

FIG. 4 depicts an example of failure cause estimation in an IT system. FIG. 4 depicts an example estimation of a cause of a failure that has occurred for a connection at a multi-vendor-antenna base station (specifically between a radio unit (“RU”) and a base station control unit (or distributed unit “DU”). In this example, it is assumed that an RU 32 has been added to a system operating with an RU 31 and a DU 33. The RU 31 and the DU 33 are manufactured by the same manufacturer (“vendor A”), but the RU 32 is manufactured by another manufacturer (“vendor B”). In such cases, a failure may occur in the system due to the addition of the RU 32.

When a failure has occurred, the cause of the failure is estimated at the server 100 by inputting information relating to the failure that has occurred into the server 100. As one example, the server 100 analyzes the possibility of each potential cause of failure being the cause of the failure that occurred. The server 100 estimates a phenomenon that is a root cause of the failure from such analysis results.

Potential causes of a communication failure include a hardware (HW) failure or compatibility problem, an RU-SW (switch) or DU-SW compatibility problem, and a setting error for XX, where XX is a setting parameter.

In this way, there are many potential causes of failure. In recent years, system configurations have become complex due to virtualization and multi-vendor compatibility, resulting in the causes of failures becoming more diverse. As a result, it is increasingly difficult to estimate the cause of a failure.

To estimate the cause of a failure, a document indicating failures that occurred in the past and the causes of such failures may be used. As one example, by using an LLM, it is possible to estimate a failure cause based on a large number of documents.

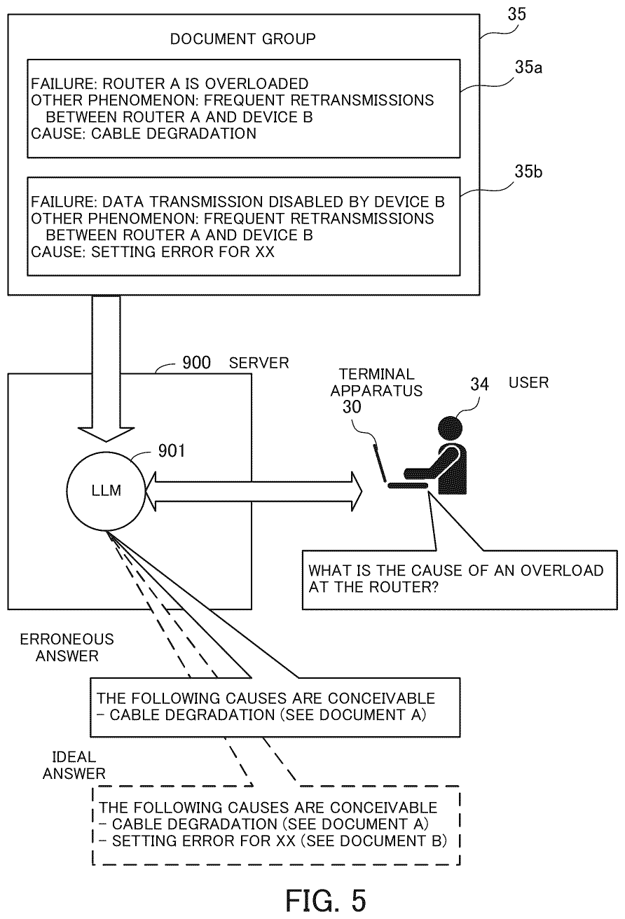

FIG. 5 depicts an example of failure cause estimation using an LLM. As one example, a document group 35 indicating failures that occurred in the past in the IT system to be managed, other phenomena that occurred along with such failures, and the causes of such failures is prepared in advance. The document group 35 includes documents 35a and 35b for different failures.

An LLM 901 is implemented in a server 900. By using the LLM 901, the server 900 is capable of conversing in natural language with the terminal apparatus 30 and providing an answer indicating the cause of a failure. As one example, the user 34 may input the question “What is the cause of an overload at the router?” into the terminal apparatus 30. The terminal apparatus 30 transmits a character string indicating the question to the server 900. The server 900 performs inference using the question as an input into the LLM 901. The LLM 901 is a trained model that performs inference by referring to the document group 35. On obtaining an answer outputted from the LLM 901, the server 900 transmits the outputted answer to the terminal apparatus 30.

When the server 900 performs inference by referring to the document group 35 without using a KG for example, the plurality of documents 35a and 35b will be referred to individually. In the example in FIG. 5, the failure in the document 35a is “router A is overloaded”. This is similar to the content of the failure indicated by the user 34's question. The server 900 therefore transmits “The following causes are conceivable-cable degradation (see Document A)” to the terminal apparatus 30, for example.

In reality, the number of potential causes of an overload at a router is not limited to one. As another example, a router may become overloaded due to a setting error at a network device. An answer in which potential causes are listed, saying for example “The following causes are conceivable—cable degradation (see Document A)—Setting error for XX (see Document B)” would therefore be ideal.

In this way, during inference using the LLM 901, since the plurality of documents 35a and 35b are referred to only individually, the server 900 is incapable of recognizing any relatedness between the documents 35a and 35b. In the example in FIG. 5, it is not possible to recognize that “setting error for XX” indicated in the document 35b also relates to a failure. It is therefore difficult to obtain an ideal answer by inference using only the LLM 901.

A KG represents relations between pieces of knowledge. It would therefore be conceivable to use an inference technique that uses a KG to estimate the cause of a failure.

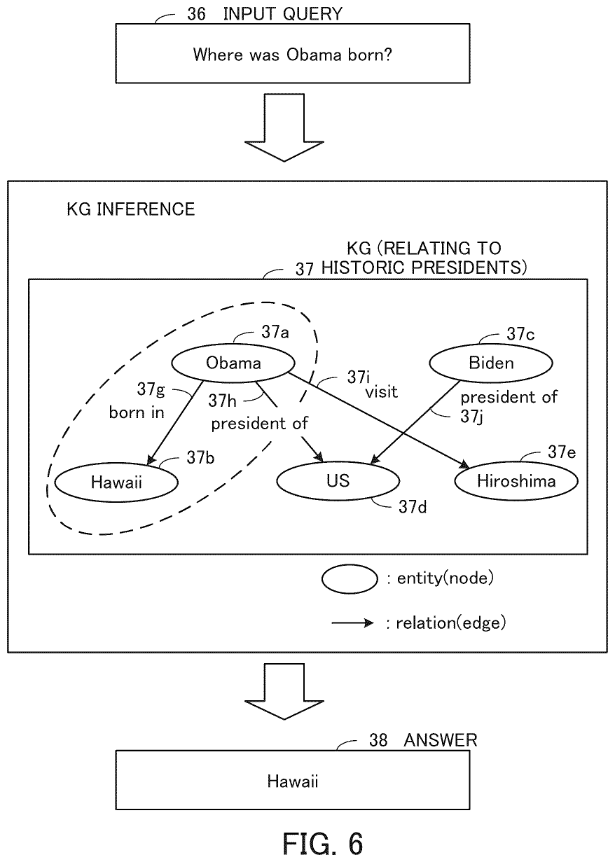

FIG. 6 depicts examples of KG inference. As example, it is assumed that a KG 37 relating to historical presidents of the USA has been generated in advance. The KG 37 includes a plurality of nodes 37a to 37e indicating entities and edges 37g to 37j indicating relations. Each entity is information that refers to an object in the world, a concept, a matter, or the like. The nodes 37a to 37e are represented by shapes such as ovals, and the edges 37g to 37j are represented by arrows connecting the nodes 37a to 37e.

In KG inference, structured data in the KG 37 is used to infer an appropriate answer to an input query 36. As one example, in the case of input query 36 that queries the birthplace of former President Obama, an entity indicating the name of the president is specified. Out of the edges 37g to 37i connected to the node 37a of this entity, the edge 37g of a relation relating to the birthplace is specified. The entity represented by a node 37b connected to the specified edge 37g is outputted as an answer 38. In the example in FIG. 6, “Hawaii” is obtained as the answer 38.

When KG inference like this is applied to failure cause estimation, it is possible to perform inference that considers the relationships between documents. The server 100 according to the second embodiment refers to a KG (a causal relationship KG) indicating causal relationships of failures and finds an appropriate failure cause and an estimation result thereof, which correspond to a failure case indicated by the input query, as the answer.

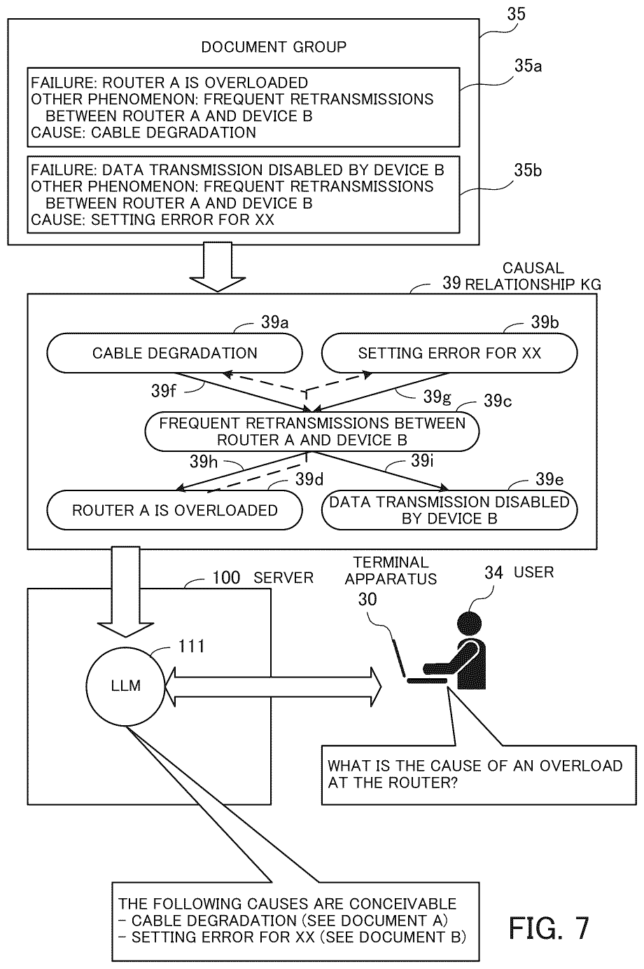

FIG. 7 depicts one example of failure cause estimation using a causal relationship KG. A causal relationship KG 39 may be generated based on the document group 35 including the plurality of documents 35a and 35b. The causal relationship KG 39 is represented by nodes 39a to 39e corresponding to entities indicating phenomena relating to failures and edges 39f to 39i indicating causal relationships between the entities. The phenomena indicated by the entities include phenomena recognized as failures, phenomena that may be the root cause of a failure, and other phenomena.

As one example, an entity indicating the failure “router A overloaded” in the document 35a is represented by the node 39d. An entity indicating the phenomenon “frequent retransmissions between router A and device B” in the document 35a is represented by the node 39c. An entity indicating the cause “cable degradation” in the document 35a is represented by the node 39a.

An entity indicating the failure “data transmission disabled by device B” in the document 35b is represented by the node 39e. An entity indicating the phenomenon “frequent retransmissions between router A and device B” in the document 35b is represented by the node 39c. An entity indicating the cause “setting error for XX” in the document 35b is represented by the node 39b.

The edges 39f and 39g indicating causal relationships are set from nodes corresponding to entities of causes in the documents 35a and 35b to nodes corresponding to entities of phenomena. The edges 39h and 39i indicating causal relationships are set from nodes corresponding to entities of phenomena in the documents 35a and 35b to the nodes corresponding to entities of failures.

The documents 35a and 35b include i a common phenomenon. For this reason, an entity representing a phenomenon in both the documents 35a and 35b is represented by the same node 39c. The generated causal relationship KG 39 is stored in the server 100, for example.

When the user 34 inputs a question into the terminal apparatus 30, the question is transmitted from the terminal apparatus 30 to the server 100 as an input query. As one example, when the input query is “What is the cause of the router being overloaded?”, the server 100 inputs an input query into an LLM 111. The server 100 then executes information processing according to the LLM 111 by referring to the causal relationship KG 39 and obtains an output of the LLM 111.

As one example, the server 100 specifies the nodes 39a and 39b that are reached by tracing edges that have the node 39d, which corresponds to the entity “the router A is in an overloaded state” in the causal relationship KG 39, as the starting point in the reverse direction of the arrows. The server 100 then outputs, as the answer, the causes of the failures indicated by the entities corresponding to the reached nodes 39a and 39b. By doing so, an answer indicating a plurality of candidates as the cause of the failure is obtained. Note that by using the LLM 111, it is possible to express the content of the answer using a character string in natural language.

For the example in FIG. 7, when a plurality of entities may be the cause of a failure, a plurality of entities are presented to the user 34 as the answer, but information on which entity is likely to be the cause of the failure is not indicated. By using the causal relationship KG 39 effectively, it is possible to evaluate the likelihood of each entity being the cause of the failure. For this reason, the server 100 evaluates, for each entity that may be the cause of a failure, the likelihood using a confidence score and presents entities with a high confidence score to the user 34. By doing so, an appropriate failure cause is presented to the user 34.

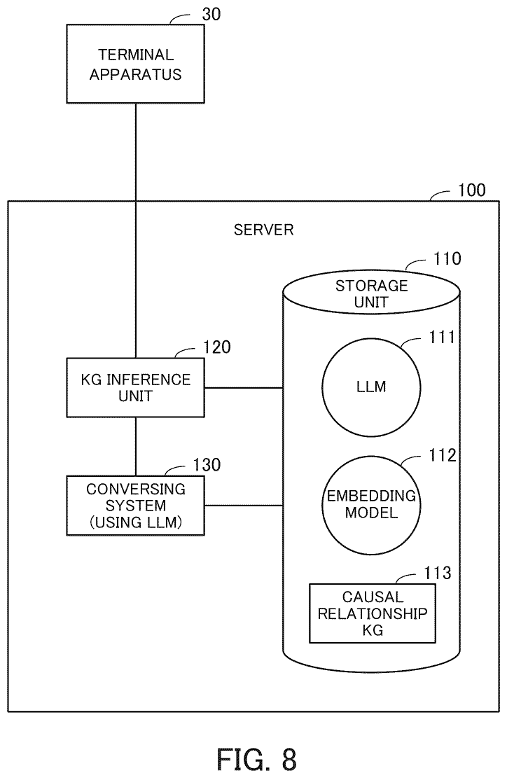

FIG. 8 is a block diagram depicting a function for estimating the cause of a failure at a server. The server 100 includes a storage unit 110, a KG inference unit 120, and a conversing system 130. The storage unit 110 stores the LLM 111, an embedding model 112, and a causal relationship KG 113.

The LLM 111 is a language model of a trained neural network. The LLM 111 is a model capable of inputting a sentence in natural language (or data obtained by encoding such sentence) and outputting an answer to a question indicated by the sentence in the natural language.

The embedding model 112 is a trained model for converting a natural language sentence into a numerical vector based on terms included in the sentence.

The causal relationship KG 113 is a KG generated based on documents representing the causes of failures. The causal relationship KG 113 is a graph representing relations between the causes of failures, phenomena that occur based on such causes, and failures that occur.

The KG inference unit 120 performs failure cause estimation based on the causal relationship KG 113 in cooperation with the conversing system 130 that uses the LLM 111. As one example, when the KG inference unit 120 has acquired an input query including a character string of a question from the terminal apparatus 30, the KG inference unit 120 decomposes the input query into a description relating to a failure and a description relating to other phenomena. The decomposition of the input query may be performed using the conversing system 130. As one example, the KG inference unit 120 inputs a prompt indicating decomposition of the input query into the conversing system 130. The conversing system 130 then decomposes the sentence indicated in the input query into sub-queries using the LLM 111.

The KG inference unit 120 also searches the causal relationship KG for a plurality of entities (or “similar entities”) that are similar to each decomposed sub-query. As one example, the KG inference unit 120 converts each sub-query into a numerical vector using the embedding model 112.

The KG inference unit 120 calculates a confidence score of a failure cause (or “root cause”) indicated by a path (or “root cause path”) starting from each similar entity found in the search. As one example, the KG inference unit 120 generates a subKG including such path. The KG inference unit 120 then calculates a confidence score of each subKG according to a combination of similar entities included in that subKG and the similarity between the similar entities and the sub-query.

The KG inference unit 120 arranges failure causes whose calculated confidence scores are equal to or greater than a threshold value and the estimation results thereof in order of the confidence scores and transmits the failure causes and estimation results to the terminal apparatus 30 as the answer.

The conversing system 130 converses in natural language using the LLM 111. As one example, when a prompt indicating division of an input query has been inputted from the KG inference unit 120, the conversing system 130 decomposes the input query for example into a description relating to a failure and a description relating to other phenomena. The conversing system 130 then transmits each description obtained by the decomposition to the KG inference unit 120 as a sub-query.

Note that the functions of the respective elements depicted in FIG. 8 may be implemented by causing the processor 101 to execute a program module corresponding to such elements, for example.

Next, the causal relationship KG 113 will be described in more detail.

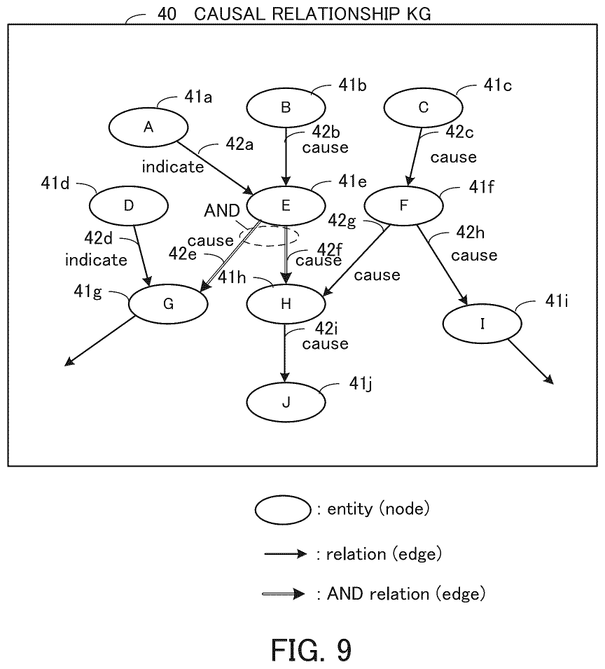

FIG. 9 depicts one example of a causal relationship KG. FIG. 9 depicts part of a causal relationship KG 40. The causal relationship KG 40 includes nodes 41a to 41j corresponding to entities. The nodes 41a to 41j are connected by edges 42a to 42i indicating relationships between entities. Such relationships include “cause” relationships and “indicate” relationships.

An edge indicating a “cause” relationship is an arrow connecting a node of an entity indicating the cause of a phenomenon to a node of another entity which occurs due to such entity occurring. An edge indicating an “indicate” relationship is an arrow connecting a node of an entity indicating information on a phenomenon that occurred (for example, a log of the occurred phenomenon) to a node of an entity indicating the phenomenon that occurred.

The node 41a of an entity “A” is connected to the node 41e of an entity “E” by the edge 42a indicating an “indicate” relationship. The node 41b of an entity “B” is connected to the node 41e of the entity “E” by the edge 42b indicating a “cause” relationship. The node 41c of the entity “C” is connected to the node 41f of an entity “F” by the edge 42c indicating a “cause” relationship. The node 41d of an entity “D” is connected to the node 41g of an entity “G” by the edge 42d indicating an “indicate” relationship. The node 41e of the entity “E” is connected to the node 41g of the entity “G” by the edge 42e indicating a “cause” relationship. The node 41e of the entity “E” is connected to the node 41h of the entity “H” by the edge 42f indicating a “cause” relationship. The node 41f of the entity “F” is connected to the node 41h of an entity “H” by the edge 42g indicating a “cause” relationship. The node 41f of the entity “F” is connected to the node 411 of an entity “I” by the edge 42h indicating a “cause” relationship. The node 41h of the entity “H” is connected to the node 41j of an entity “J” by the edge 42i indicating a “cause” relationship.

The edges 42e and 42f indicated by double lines connected from the node 41e to the nodes 41g and 41h in the causal relationship KG 40 indicate an AND relationship. An AND relationship indicates that when an entity that is the source of the relationship occurs, a plurality of entities that are the destinations of the relationship may occur simultaneously. The term “simultaneously” as used in the present specification means that a plurality of entities occur with the occurrence of the same entity as a trigger, and the timing at which such entities occur may actually differ.

Next, the procedure of KG inference processing using the causal relationship KG 40 will be described.

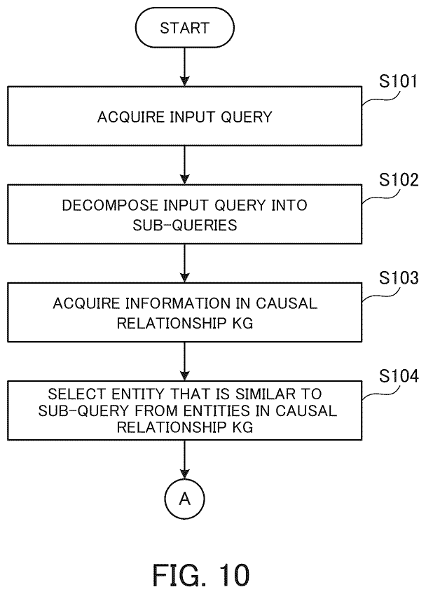

FIG. 10 is (a first part of) a flowchart depicting an example procedure of KG inference processing. The processing depicted in FIG. 10 will be described below in order of the step numbers.
[Step S101] The KG inference unit 120 acquires an input query from the terminal apparatus 30. The input query includes a description relating to a failure, a description relating to other phenomena, and the like.
[Step S102] The KG inference unit 120 decomposes the input query into sub-queries. As one example, the KG inference unit 120 receives an input of a prompt instructing the conversing system 130 to decompose the input query and transmits the input query to the conversing system 130. The conversing system 130 interprets the meaning of the sentence of the input query using the LLM 111, and decomposes the input query into a description relating to a failure and a description relating to other phenomena. The conversing system 130 transmits each decomposed description to the KG inference unit 120 as a sub-query.
[Step S103] The KG inference unit 120 acquires information in the causal relationship KG 40. As one example, the KG inference unit 120 acquires information on entities corresponding to each node in the causal relationship KG 40 and information on the relationships corresponding to each edge.
[Step S104] The KG inference unit 120 selects entities that are similar to the respective sub-queries by searching the entities in the causal relationship KG 40. As one example, the KG inference unit 120 calculates the similarity between each sub-query and each entity. The KG inference unit 120 then specifies a predetermined number of entities in descending order of similarity for each sub-query.

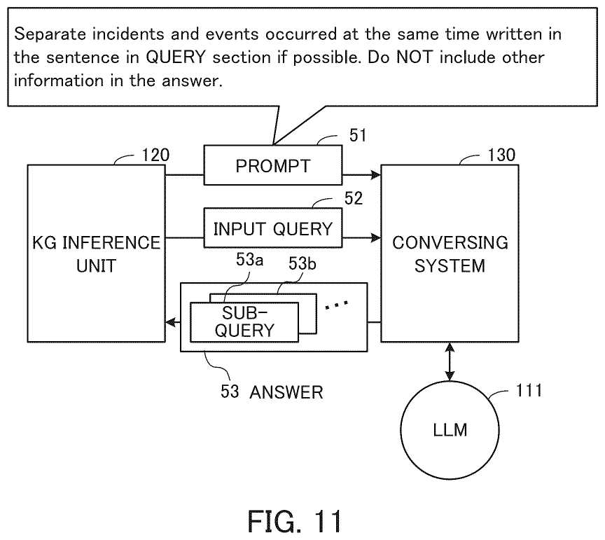

FIG. 11 depicts one example of division processing for an input query. A prompt 51 is inputted from the KG inference unit 120 into the conversing system 130 that uses the LLM 111. As one example, the prompt 51 is a character string “Separate incidents and events occurred at the same time written in the sentence in QUERY section if possible. Do NOT include other information in the answer”. The prompt 51 instructs that the sentence of the input query 52 is to be decomposed into a “description relating to a failure” and a “description relating to other phenomenon”, and other information is not to be included.

The KG inference unit 120 inputs the input query 52 into the conversing system 130 following the prompt 51. The conversing system 130 decomposes the sentence indicated by the input query 52 into a plurality of descriptions using the LLM 111. The conversing system 130 then transmits an answer 53 including the sub-queries 53a, 53b, . . . for each decomposed description to the KG inference unit 120.

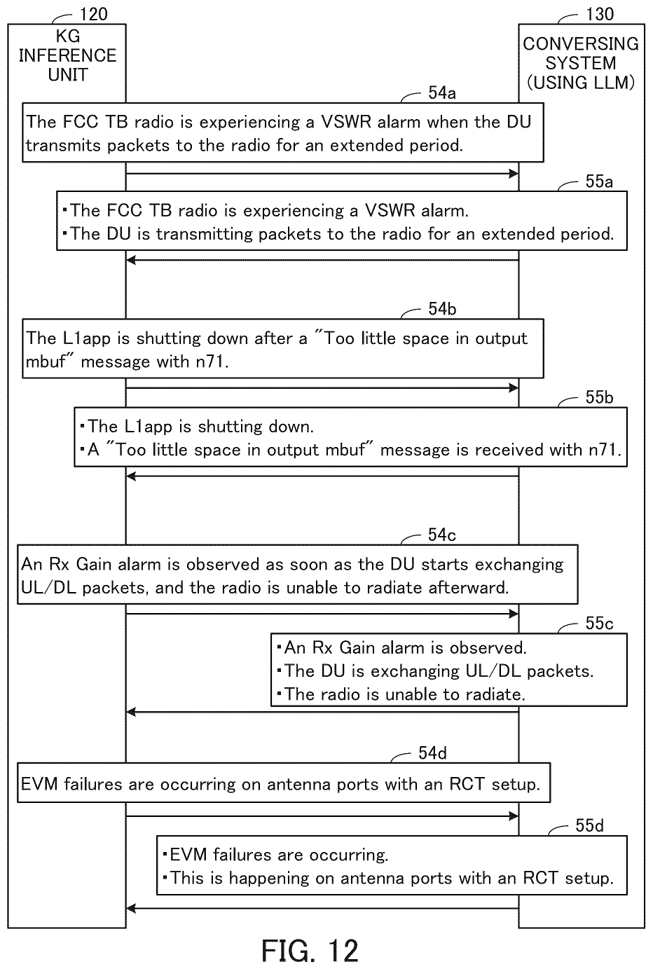

FIG. 12 depicts examples of sub-queries obtained by decomposing an input query. As one example, when an input query 54a of a sentence “The FCC TB radio is experiencing a VSWR alarm when the DU transmits packets to the radio for an extended period” has been inputted into the conversing system 130, an answer 55a is transmitted from the conversing system 130. The answer 55a includes descriptions of “The FCC TB radio is experiencing a VSWR alarm” and “The DU is transmitting packets to the radio for an extended period” as sub-queries.

When an input query 54b of a sentence “The L1app is shutting down after a ‘Too little space in output mbuf’ message with n71” has been inputted into the conversing system 130, an answer 55b is transmitted from the conversing system 130. The answer 55b includes descriptions of “The L1app is shutting down” and “A ‘Too little space in output mbuf’ message is received with n71” as sub-queries.

When an input query 54c of a sentence “An Rx Gain alarm is observed as soon as the DU starts exchanging UL/DL packets, and the radio is unable to radiate afterward” has been inputted into the conversing system 130, an answer 55c is transmitted from the conversing system 130. The answer 55c includes descriptions of “An Rx Gain alarm is observed”, “The DU is exchanging UL/DL packets”, and “The radio is unavailable to radiate” as sub-queries.

When an input query 54d of a sentence “EVM failures are occurring on antenna ports with an RCT setup.” has been inputted into the conversing system 130, an answer 55d is transmitted from the conversing system 130. The answer 55d includes descriptions of “EVM failures are occurring” and “This is happening on antenna ports with an RCT setup” as sub-queries.

In this way, by using the LLM 111, various sentences indicated in an input query are decomposed into a “description relating to a failure” and a “description relating to other phenomena”. Based on the sub-queries, the KG inference unit 120 calculates the similarity between each sub-query represented by a description produced by decomposition and entities represented by nodes in the causal relationship KG.

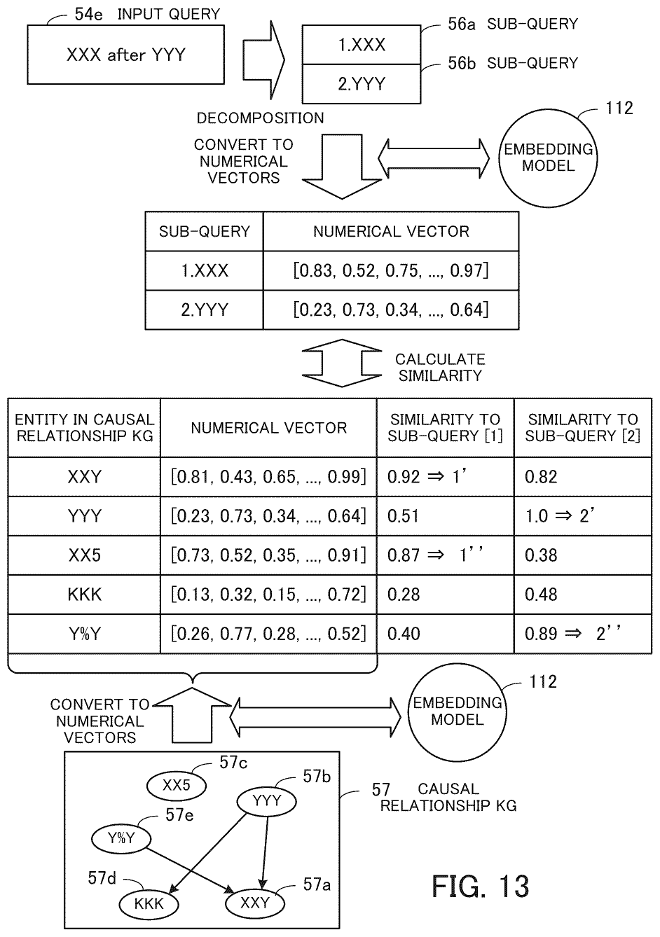

FIG. 13 depicts an example calculation method of similarity. It is assumed that two sub-queries 56a and 56b have been generated by decomposing an input query 54e. The sub-query 56a includes “description relating to a failure”, and the sub-query 56b includes “description relating to other phenomena”.

The KG inference unit 120 converts the sub-queries 56a and 56b into numerical vectors using the embedding model 112, for example. By using the embedding model 112, the descriptions in the sub-queries 56a and 56b are mathematically embedded from a space with a number of dimensions that is equal to the number of words into a vector space with fewer dimensions. As one example, the embedding model 112 is a deep learning model called a “transformer”.

The KG inference unit 120 also converts entities indicated by the nodes 57a to 57e included in the causal relationship KG 57 into numerical vectors using the embedding model 112. The KG inference unit 120 then calculates the similarity between each of the sub-queries 56a and 56b and each entity indicated by the nodes 57a to 57e in the causal relationship KG 57 by comparing the numerical vectors. As one example, the KG inference unit 120 sets the cosine similarity between the numerical vectors as the similarity between the sub-queries 56a and 56b and the entities indicated by the nodes 57a to 57e.

In the example in FIG. 13, the similarity between the sub-query 56a and the entity indicated by the node 57a is “0.92”. The similarity between the sub-query 56a and the entity indicated by the node 57b is “0.51”. The similarity between the sub-query 56a and the entity indicated by the node 57c is “0.87”. The similarity between the sub-query 56a and the entity indicated by the node 57d is “0.28”. The similarity between the sub-query 56a and the entity indicated by the node 57e is “0.40”.

The similarity between the sub-query 56b and the entity indicated by the node 57a is “0.82”. Since the sub-query 56b and the entity indicated by the node 57b have the same description content “YYY”, the similarity is “1.0”. The similarity between the sub-query 56b and the entity indicated by the node 57c is “0.38”. The similarity between the sub-query 56b and the entity indicated by the node 57d is “0.48”. The similarity between the sub-query 56b and the entity indicated by the node 57e is “0.89”.

For each of the sub-queries 56a and 56b, the KG inference unit 120 searches the causal relationship KG 57 for the most similar top n entities (where n is a natural number). The KG inference unit 120 selects the appropriate entities and ranks the selected entities in descending order of similarity.

In the example in FIG. 13, the top two entities are selected for each of the sub-queries 56a and 56b. For the sub-query 56a, the entity indicated by the node 57a has the highest similarity, and the entity indicated by the node 57c has the second highest similarity. For the sub-query 56b, the entity indicated by the node 57b has the highest similarity, and the entity indicated by the node 57e has the second highest similarity.

Here, the entity that is most similar to the sub-query 56a is set as “1′”, and the entity that is second most similar to the sub-query 56a is set as “1″”. When a third most similar entity to the sub-query 56a is selected, such entity is set as “1′″”.

The entity most similar to the sub-query 56b is set as “2”, and the entity second most similar to the sub-query 56b is set as “2″”. When a third most similar entity to the sub-query 56b is selected, such entity is set as “2′″”.

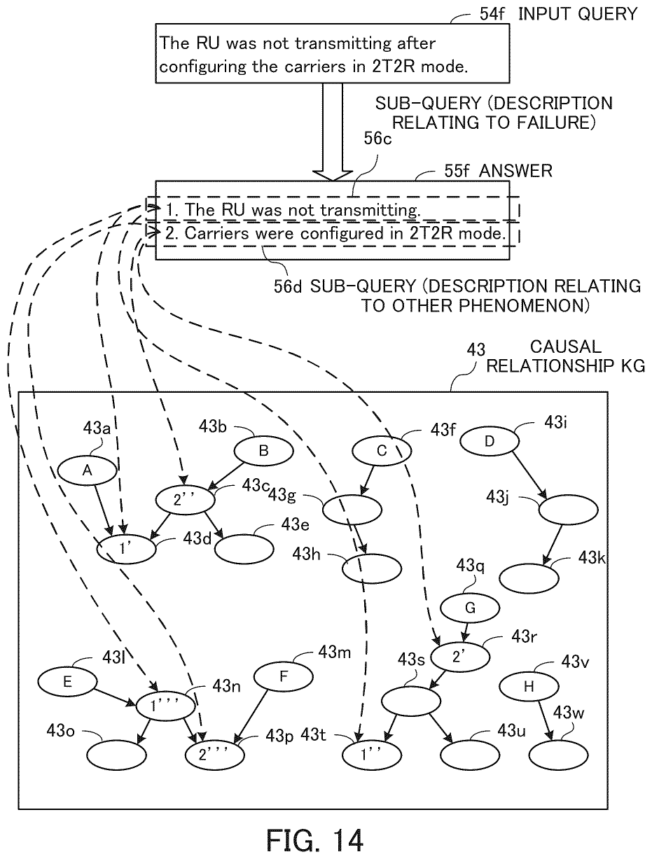

FIG. 14 depicts one example of a similar entity selection result. As one example, an answer 55f given when the sentence “The RU was not transmitting after configuring the carriers in 2T2R mode” indicated in the input query 54f is decomposed by the LLM 111 includes sub-queries 56c and 56d. The sub-query 56c is “The RU was not transmitting” and the sub-query 56d is “Carriers were configured in 2T2R mode”.

The causal relationship KG 43 includes nodes 43a to 43w that correspond to a plurality of entities. The entity that is most similar to the sub-query 56c is the entity corresponding to the node 43d. The second most similar entity to the sub-query 56c is the entity corresponding to the node 43t. The third most similar entity to the sub-query 56c is the entity corresponding to the node 43n. The entity most similar to the sub-query 56d is the entity corresponding to the node 43r. The second most similar entity to the sub-query 56d is the entity corresponding to the node 43c. The third most similar entity to the sub-query 56d is the entity corresponding to the node 43p.

Out of the nodes 43a to 43w included in the causal relationship KG 43 depicted in FIG. 14, the nodes 43a, 43b, 43f, 43i, 431, 43m, 43q, and 43v correspond to entities indicating the causes of failures.

When the search for entities (or “similar entities”) that are similar to each sub-query ends, in the KG inference processing, subKGs with the similar entities as starting points are generated and a confidence score for each subKG is calculated.

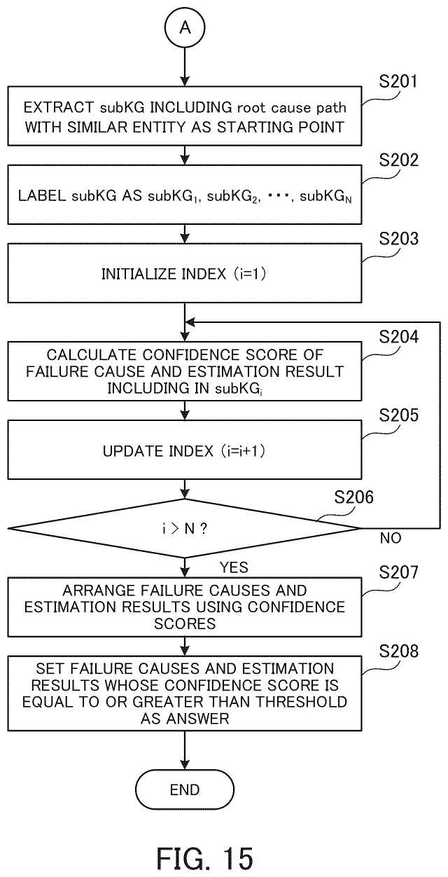

FIG. 15 is (a second part of) a flowchart depicting an example procedure of KG inference processing. The processing depicted in FIG. 15 will be described below in order of step numbers.
[Step S201] The KG inference unit 120 extracts a subKG including a path (or “root cause path”) from a similar entity as a starting point to the entity of a cause. Here, it is assumed that the total number of extracted subKGs is “N” (where N is a natural number).
[Step S202] The KG inference unit 120 labels the extracted subKGs as subKG1, subKG2, . . . , subKGN. [Step S203] The KG inference unit 120 initializes a value of an index i to “1” (that is, i=1).
[Step S204] The KG inference unit 120 calculates a failure cause obtained from a subKGᵢ and the confidence score of the estimation result in keeping with the similarity between the similar entity included in subKGᵢ and the sub-query that is similar to such similar entity.
[Step S205] The KG inference unit 120 updates the index i (that is, i=i+1).
[Step S206] The KG inference unit 120 determines whether the value of the index i is greater than “N”. When the value of the index i is greater than “N”, the KG inference unit 120 advances the processing to step S207. When the value of the index i is equal to or less than “N”, the KG inference unit 120 advances the processing to step S204.
[Step S207] The KG inference unit 120 rearranges the failure causes and their estimation results obtained from the extracted subKGs in descending order of confidence score.
[Step S208] The KG inference unit 120 sends failure causes whose confidence scores are equal to or greater than a threshold value and an estimation result of such failure results to the terminal apparatus 30 as the answer.

In this way, it is possible to provide failure causes with a high confidence level and estimation results of such failure causes as an answer. In addition, a causal relationship KG is generated based on information (a document group) relating to failures that occurred in the past. This means that by calculating the confidence scores based on the causal relationship KG, the occurrence of hallucinations is suppressed.

Next, a process of generating a path (or “root cause path”) with a similar entity as the starting point will be described in more detail.

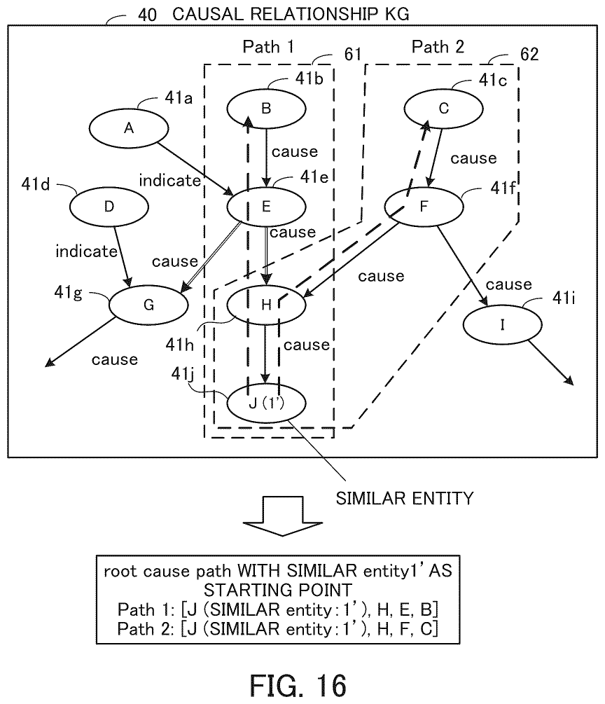

FIG. 16 depicts an example process of generating a path with a similar entity as a starting point. As one example, it is assumed that the entity “J” corresponding to the node 41j is the similar entity that is most similar to the sub-query “description relating to a failure”.

The KG inference unit 120 traces the nodes connected by an edge of a causal relationship (that is, the relation labelled as “cause”) from the node 41j of the similar entity “J” in the causal relationship KG 40 upward (that is, in the reverse direction of the arrow) to the end node. When the path that traces nodes branches midway (that is, two or more higher-order nodes are connected by relations labelled as “cause”), the KG inference unit 120 generates another new path including the path before the branch. In the example of the causal relationship KG 40, the path branches at the node 41h. Due to this, two paths 61 and 62 are generated with the node 41j as the starting point.

The path 61 is a path that traces nodes in the order of the node 41j (entity “J”) which is the similar entity “1′”, the node 41h (entity “H”), the node 41e (entity “E”), and the node 41b (entity “B”). The entity “B” is an entity indicating a failure cause.

The path 62 is a path that traces nodes in the order of the node 41j (entity “J”) which is the similar entity “1”, the node 41h (entity “H”), the node 41f (entity “F”), and the node 41c (entity “C”). The entity “C” is an entity indicating a failure cause.

When a path (or “root cause path”) is generated, the KG inference unit 120 extracts, for each path, a subKG including that path from the causal relationship KG 40.

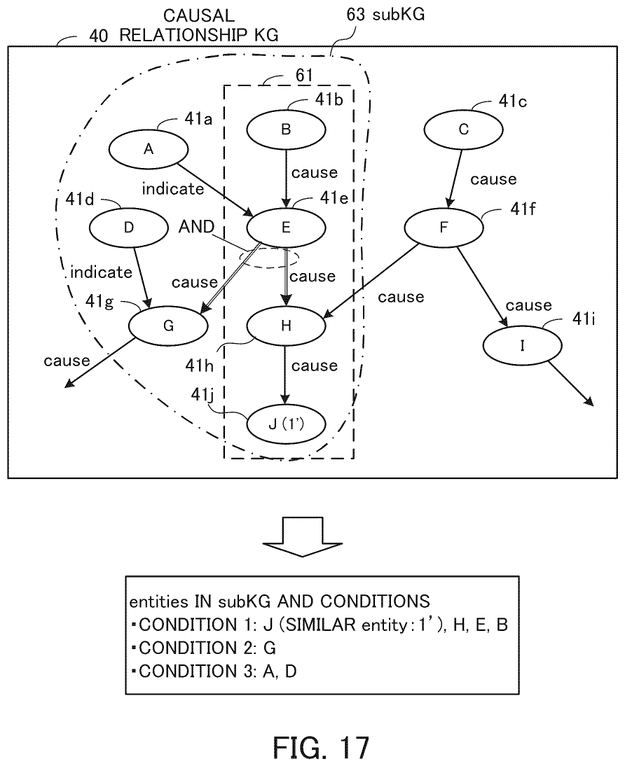

FIG. 17 depicts one example of a subKG extraction method. The KG inference unit 120 extracts, from the causal relationship KG 40, a subgraph that includes entities satisfying any of the following conditions and relations between such entities and sets the subgraph as a subKG.
Condition 1: Entities included on a path (root cause path)·
Condition 2: An entity connected to an entity included on a path (root cause path) by an AND relationship (entities that occur simultaneously with an entity that is a relation destination).
Condition 3: an entity connected to an entity corresponding to the conditions 1 and 2 by a relation indicating the occurrence of a phenomenon (that is, a relation labelled “indicate”).

For the example in FIG. 17, first, the entities “J, H, E, B” included on the path 61 are extracted according to Condition 1. Next, according to Condition 2, the entity “G” that is connected to the entity “E” in an AND relationship is extracted. In addition, according to Condition 3, the entities “A” and “D” connected to the entities “E” and “G” in an “indicate” relationship are extracted. A subKG 63 indicating the extracted entities and the relationships that connect the entities is then extracted.

As one example, a plurality of subKGs are extracted by extracting a subKG using each similar entity that is similar to any of the sub-queries as a starting point. A confidence score is then calculated for each of the plurality of subKGs.

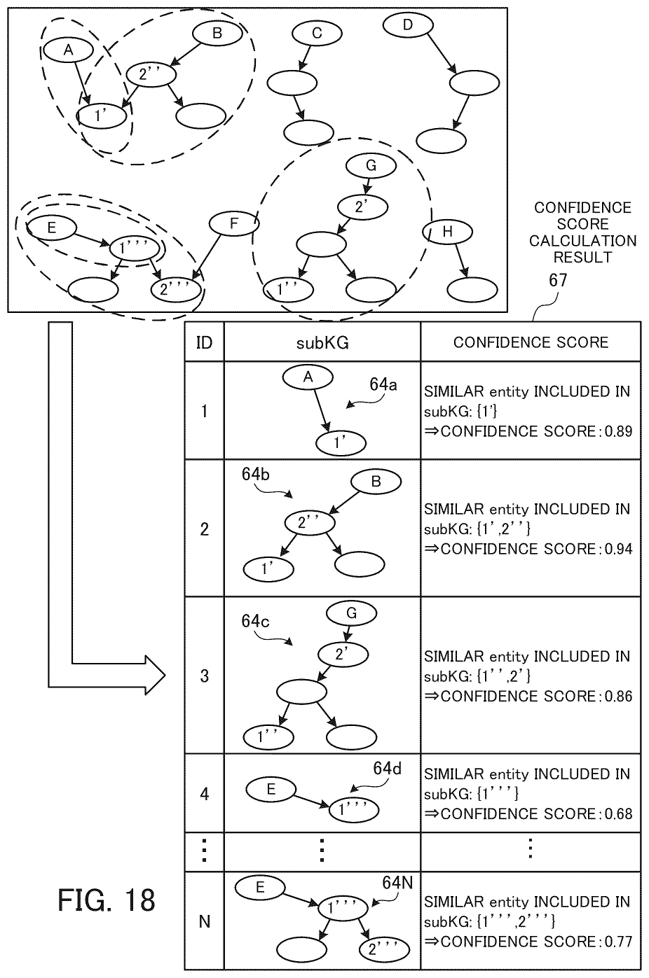

FIG. 18 depicts an example calculation of a confidence score for each subKG. As one example, subKGs 64a and 64b are extracted with a similar entity “1′” that is similar to “sub-query 1” as a starting point. A subKG 64c is also extracted with a similar entity “1″” as the starting point. A subKG 64d is extracted with the similar entity “1′″” as the starting point.

In the same way, subKG including similar entities that are similar to “sub-query 2” as the starting point are extracted. As one example, subKG 64N is extracted with a similar entity “2′″” as the starting point.

A confidence score is calculated for each of the extracted subKGs 64a, 64b, 64c, 64d, . . . , 64N. The calculated confidence scores are associated with the subKGs 64a, 64b, 64c, 64d, . . . , 64N subjected to calculation and are stored in the memory 102 for example as a confidence score calculation result 67.

When calculating a confidence score, as one example, the similarity to the sub-query of the similar entity included in the subKG subjected to calculation is used. When doing so, the higher the similarity of the similar entity included in the subKG, the higher the confidence score of the subKG.

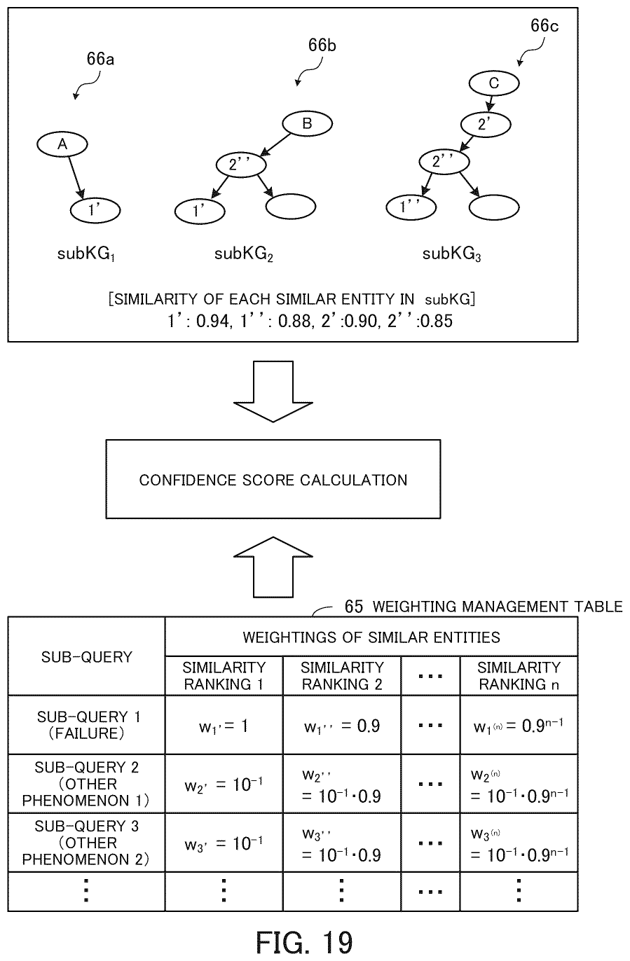

FIG. 19 depicts an example method of calculating a confidence score. As one example, the KG inference unit 120 includes a weighting management table 65. Weightings for similar entities are set in the weighting management table 65. As one example, weightings of similar entities in keeping with the order of similarity to a sub-query are set for each sub-query in the weighting management table 65.

As one example, the weighting of a similar entity with the highest similarity (or similarity ranking 1) to a sub-query (here, the sub-query 1) “description relating to a failure” is “w_{1′}=1”. The weighting of the similar entity with the second highest similarity (or similarity ranking 2) to the sub-query is “w_{1″}=0.9”. The weighting of a similar entity with the n^{th} (where n is a natural number) highest similarity (that is, similarity ranking n) to the sub-query is “w₁₍ₙ₎=0.9ⁿ⁻¹” (where (n) indicates a superscript of 1).

The weighting of a similar entity with the highest similarity (or similarity ranking 1) to the sub-query (here, the sub-query 2) of “description relating to other phenomena” is “w_{2′}=10⁻¹”. The weighting of the similar entity with the second highest similarity (similarity ranking 2) to the sub-query is “w_{2″}=10⁻¹·0.9”. The weighting of a similar entity with the n^{th} (where n is a natural number) highest similarity (the similarity ranking n) to the sub-query is “w₂₍ₙ₎=10⁻¹·0.9ⁿ⁻¹” (where (n) indicates a superscript of 2).

The weightings of similar entities similar to sub-queries (sub-query 3, . . . ) of “description relating to other phenomena” aside from “sub-query 2” are the same as the weightings of “sub-query 2”.

As one example, it is assumed that three subKGs 66a to 66c are extracted from the causal relationship KG. The label of the subKG 66a is “1”, the label of the subKG 66b is “2”, and the label of the subKG 66c is “3”.

In the subKGs 66a to 66c, the top two entities similar to “sub-query 1” and “sub-query 2” are specified as similar entities. The similarity of the similar entity “1′” to the “sub-query 1” is “0.94”. The similarity of the similar entity “1″” to the “sub-query 1” is “0.88”. The similarity of the similar entity “2” to the “sub-query 2” is “0.90”. The similarity of the similar entity “2″” to the “sub-query 2” is “0.85”.

The KG inference unit 120 calculates a weighted sum of the similarities of the similar entities with the highest similarity to each sub-query out of similar entities included in the subKGs 66a to 66c. For example, the subKG 66c includes the two similar entities “2′” and “2″” for the “sub-query 2”. In this case, the similarity of the similar entity “2” with the higher similarity is used for the calculation of the weighted sum. The weighted sum of each subKG 66a to 66c is as follows:

$${subKG}_{1 :} {S}_{1} = 0.94 \times {w}_{{1}^{′}} = 0.94$$

$${subKG}_{2} : {S}_{2} = 0.94 \times {w}_{{1}^{′}} + 0.85 \times {w}_{{2}^{″}} = 1.0165$$

$${subKG}_{3} : {S}_{3} = 0.88 \times {w}_{{1}^{″}} + 0.9 \times {w}_{{2}^{′}} = 0.882$$

Next, the KG inference unit 120 multiplies each weighted sum by a coefficient k (where k=1/K) based on the number of sub-queries K (where K is a natural number) obtained by dividing the input query. In the example in FIG. 19, the number of sub-queries is “K=2” (so k=½). For this reason, the weighted sum of each subKG 66a to 66c is modified as follows:

$${subKG}_{1} : {S}_{1}^{′} = 0.94 \times k = 0 \text{.47}$$

$${subKG}_{2} : {S}_{2}^{′} = 1.0165 \times k = 0.50825$$

$${subKG}_{3} : {S}_{3}^{′} = 0.882 \times k = 0.441$$

The KG inference unit 120 also normalizes the corrected weighted sums using the coefficient k to values that are 0 or higher and 1 or lower. As one example, the KG inference unit 120 calculates “highest similarity of similar entities in subKG+ (1−highest similarity)×corrected weighted sum”. The highest similarity of the similar entities in the subKG 66a is “0.94”. The highest similarity of the similar entities in the subKG 66b is “0.94”. The highest similarity of the similar entities in the subKG 66c is “0.90”. The normalized values of the weighted sums of the subKGs 66a to 66c are therefore as follows.

$${subKG}_{1} : {S}_{1}^{″} = 0.94 + ( 1 - 0.94 ) \times 0.47 \approx 0.968$$

$${subKG}_{2} : {S}_{2}^{″} = 0.94 + ( 1 - 0.94 ) \times 0.50825 \approx 0.97$$

$${subKG}_{3} : {S}_{3}^{″} = 0.9 + ( 1 - 0.90 ) \times 0.441 \approx 0.944$$

The normalized values of the subKGs 66a to 66c are the confidence scores of the subKGs 66a to 66c. That is, the confidence score of the subKG 66a is “S₁″=0.968”. The confidence score of the subKG 66b is “S₂″=0.970”. The confidence score of the subKG 66c is “S₃″=0.944”.

In this case, the causes of the failure are arranged in the order of “B” (subKG₂), “A” (subKG₁), and “C” (subKG₃) in descending order of the confidence score.

As one example, the KG inference unit 120 arranges the failure causes and the estimation results for each subKG in descending order of the confidence score and transmits the failure causes and the estimation results to the terminal apparatus 30 as a failure cause estimation result.

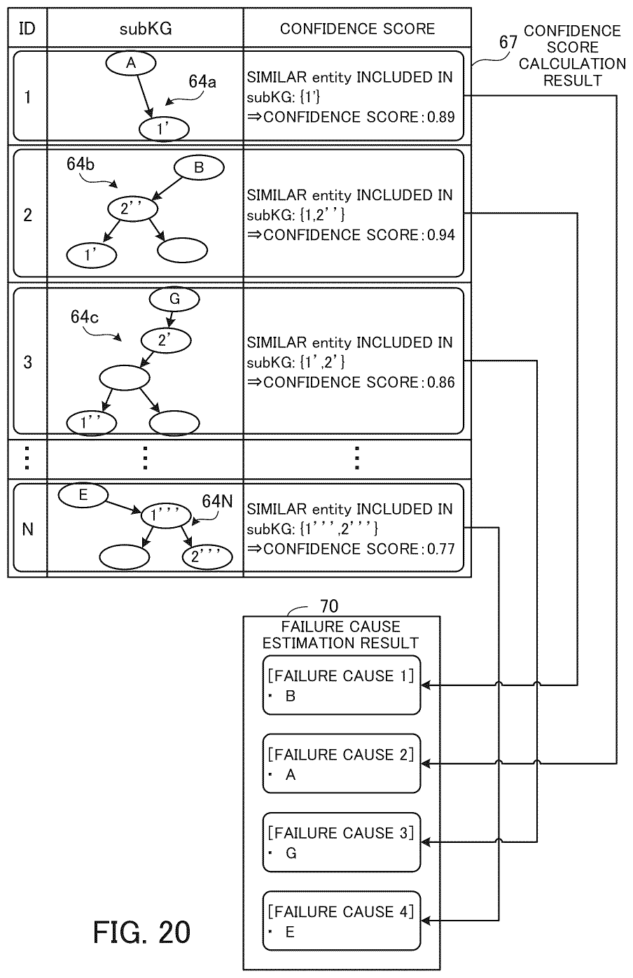

FIG. 20 depicts one example of a failure cause estimation result. In the example in FIG. 20, the confidence score of subKG 64b is the highest, the confidence score of subKG 64a is the second highest, the confidence score of subKG 64c is the third highest, and the confidence score of subKG 64N is the fourth highest. In this case, a failure cause estimation result 70 indicates each failure cause and the estimation result in the order of the failure cause “B” of the subKG 64b, the failure cause “A” of the subKG 64a, the failure cause “G” of the subKG 64c, and the failure cause “E” of the subKG 64N.

The failure cause estimation result 70 is transmitted to the terminal apparatus 30 as the answer to the input query received from the terminal apparatus 30.

The failure cause estimation result 70 is displayed for example on an answer display screen of the terminal apparatus 30.

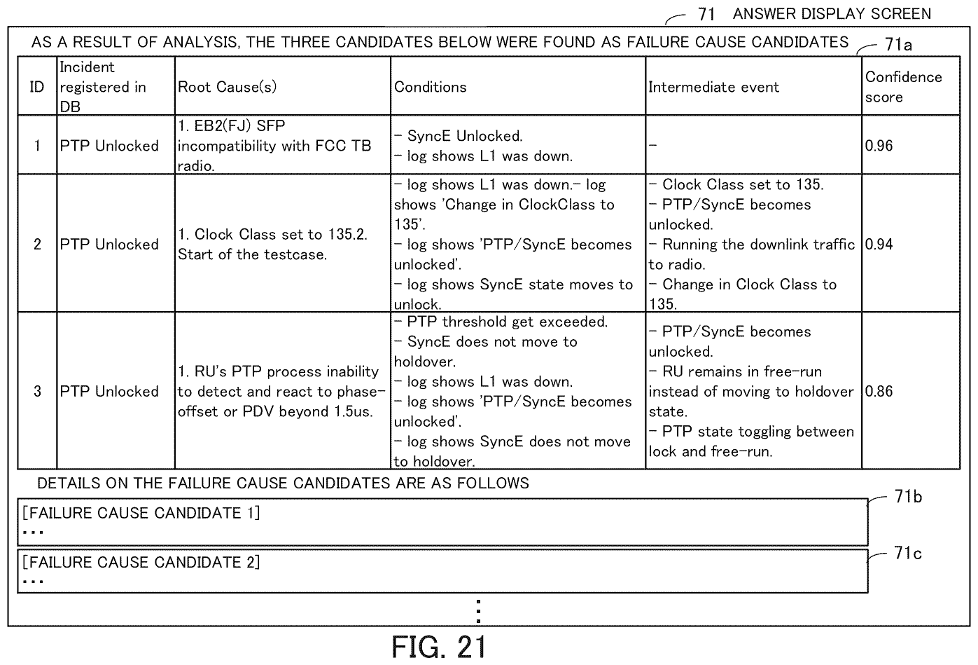

FIG. 21 depicts one example of an answer display screen. The answer display screen 71 includes a failure cause candidate display section 71a and detailed information display sections 71b, 71c, for each failure cause candidate.

In the failure cause candidate display section 71a, summaries of the estimation results of failure cause candidates are displayed in descending order of the confidence score. The estimation result summary of each failure cause candidate includes information on items such as “Incident registered in DB”, “Root Cause(s)”, “Conditions”, “Intermediate event”, and “Confidence score” in association with an ID assigned according to the ranking of the candidate. In the “Incident registered in DB” item, the content of a failure is indicated. The “Root Cause(s)” item indicates the root cause(s) of the failure. The “Conditions” item indicates a state at the time when the failure occurred as indicated in a log or the like. The “Intermediate event” item indicates information on any phenomena that occur from the occurrence of the cause of the failure to the failure itself. In the “Confidence score” item, a confidence score of a failure cause and an estimation result is indicated.

The detailed information display sections 71b, 71c, . . . display details of the estimation result of a failure cause candidate. The estimation result of the failure cause is generated for example based on a subKG including a path that reaches an entity that is a failure cause.

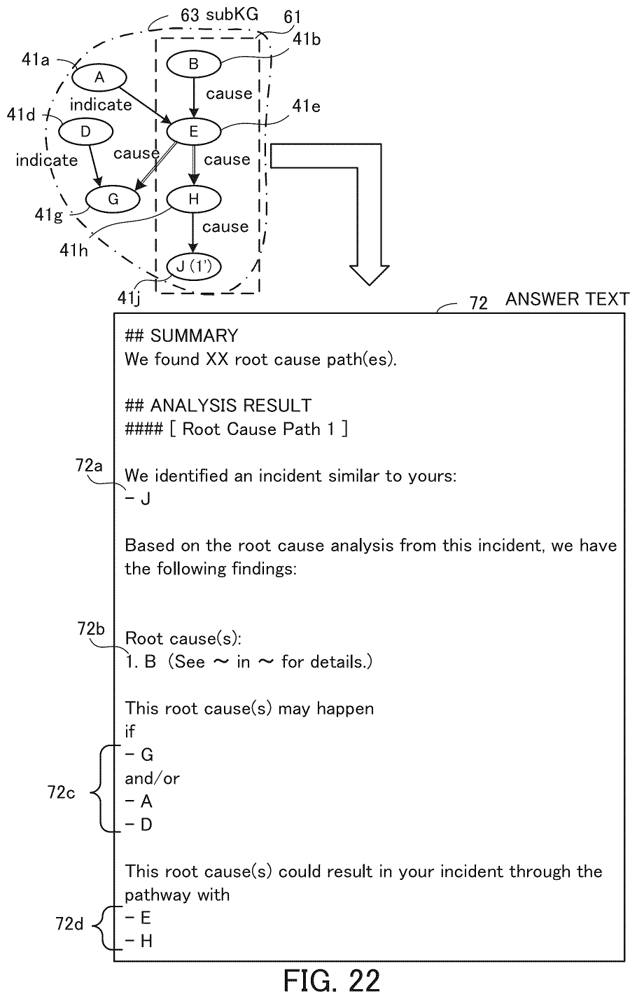

FIG. 22 depicts an example of generation processing of an estimation result of a failure cause. As one example, the KG inference unit 120 creates, based on the subKG 63, an answer text 72 indicating an estimation result that the entity “B” included in the subKG 63 is the cause of the failure.

As one example, in a similar entity display section 72a of the answer text 72, it is indicated that the similar entity that is similar to the failure indicated in the input query is “J”. The entity “J” is an entity that is a starting point of a path 61 (or “root cause path”) in the subKG 63. By displaying the similar entity, it becomes possible to confirm that the failure case intended by the user has been correctly retrieved from the causal relationship KG 40.

In a failure cause display section 72b, a root cause of the failure and a reference document location (for example, a document name and a position in the document) relating to the cause of the failure are displayed. The failure cause is the entity “B” corresponding to the uppermost node 41b on the path 61. Since the reference document is displayed in addition to the failure cause, it is easy for the user to understand the content of the failure cause.

A reference information display section 72c indicates reference information that is useful when confirming whether the presented failure cause candidate is the true cause of the failure the user wishes to resolve. The reference information is the entities “G”, “A”, and “D” included in the subKG 63 but not included on the path 61. By displaying the reference information, it is easy for the user to confirm whether the failure cause candidate is the true failure cause.

A related information display section 72d indicates related information generated from the occurrence of the cause of the failure to the failure itself. The related information is the entities “E” and “H” aside from the starting entity and the uppermost entity on the path 61. Since the related information is displayed, it is easy for the user to recognize the chained relationship of phenomena that occur before the failure itself happens due to the occurrence of the presented failure cause.

As one example, the answer text 72 is displayed in the detailed information display sections 71b, 71c, . . . of the answer display screen 71.

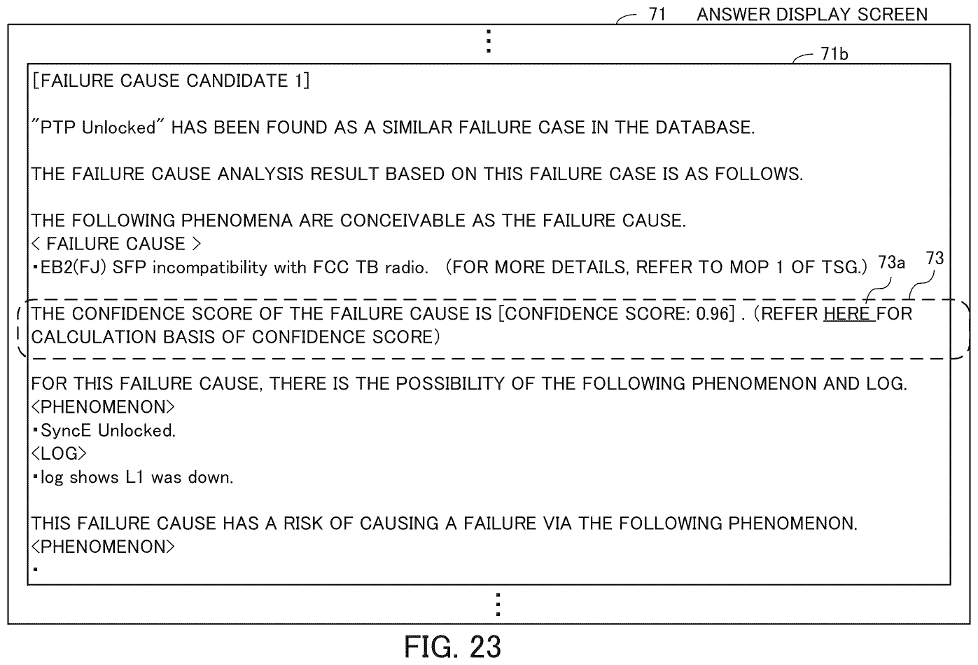

FIG. 23 depicts an example display content of a detailed information display section for a failure cause candidate. In the detailed information display section 71b, answer text indicating an estimation result of a failure cause is displayed. In the example in FIG. 23, confidence score information 73 is included in the detailed information display section 71b. The confidence score information 73 includes a link 73a to a calculation basis of the confidence score in addition to the confidence score of the failure cause candidate on display. When the link 73a is selected by the user, a confidence score calculation basis screen is displayed by another tab, a pop-up, or the like.

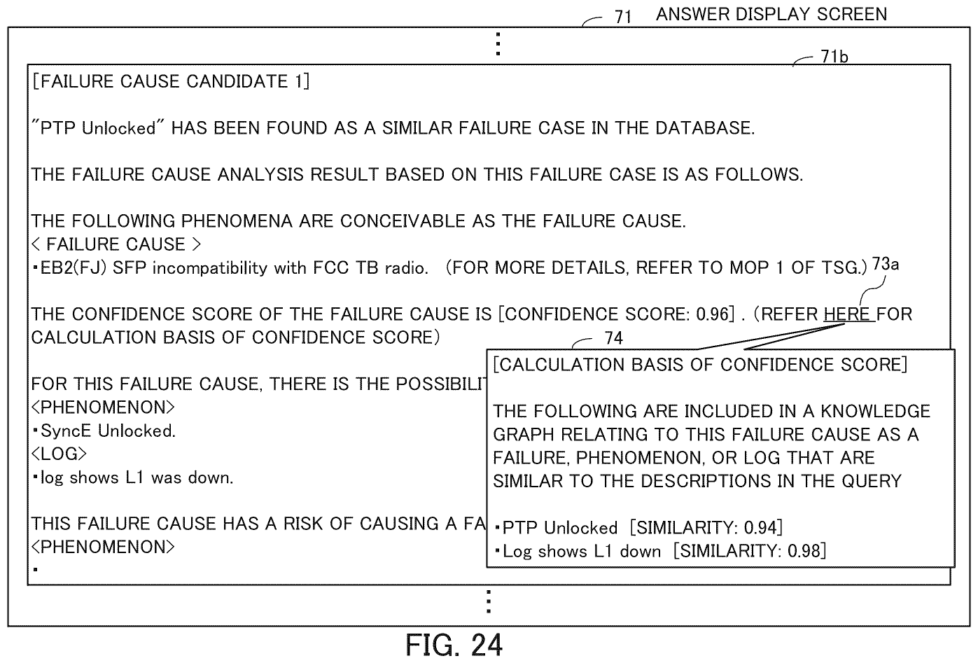

FIG. 24 depicts one example of a confidence score calculation basis screen. A confidence score calculation basis screen 74 indicates the calculation basis of the confidence score. As one example, the confidence score calculation basis screen 74 includes a similar entity included in the subKG corresponding to the failure cause on display and the similarity of the similar entity to the sub-query.

As described above, highly accurate KG inference (that is, estimation of a failure cause) in response to an input query through the use of a KG indicating causal relationships for failures is realized. In addition, the number of estimation results (failure causes) provided as answers in a failure cause estimation result is reduced, and the answers are displayed in order of confidence score. This reduces the number of steps performed by the user to check each estimation result.

### OTHER EMBODIMENTS

During or after the calculation of a confidence score, the KG inference unit 120 may use the LLM to compare the confidence score with the content of a document or specification used when generating the causal relationship KG and correct the confidence score.

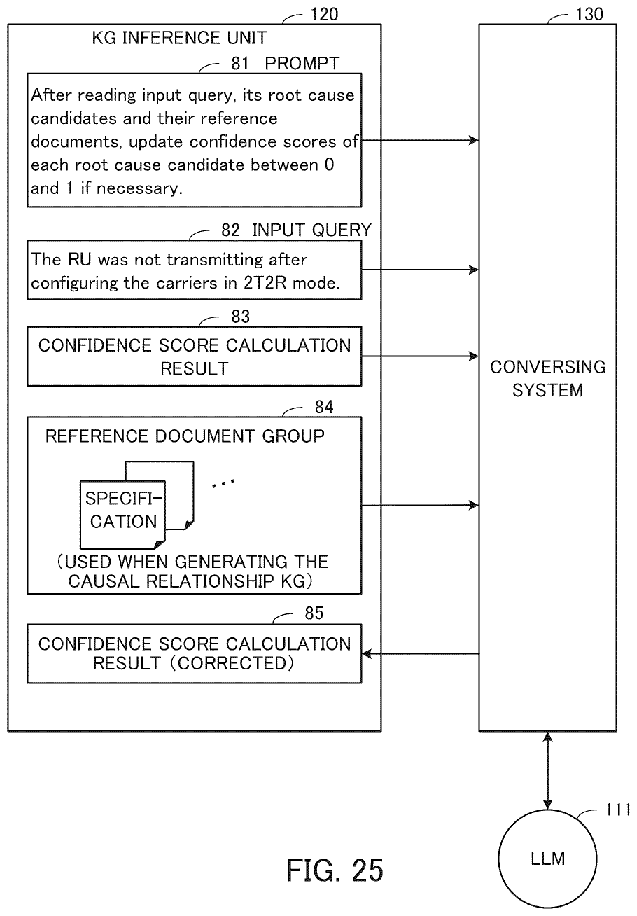

FIG. 25 depicts an example method of correcting a confidence score. As one example, the KG inference unit 120 inputs a prompt indicating an updating of the confidence score to the conversing system 130 that uses the LLM 111. As one example, the content of the prompt 81 is “After reading input query, its root cause candidates and their reference documents, update confidence scores of each root cause candidate between 0 and 1 if needed”.

After this, the KG inference unit 120 inputs an input query 82, a confidence score calculation result 83, and a reference document group 84 into the conversing system 130. The content of the input query 82 is for example a sentence “The RU was not transmitting after configuring the carriers in 2T2R mode”. As examples, the reference document group 84 is a document such as a specification used for generating the causal relationship KG and log data at the time of system operation. The conversing system 130 corrects the confidence score according to the instruction in the prompt 81.

As one example, there may be a case where a previously restored failure indicated in a document indicating a restoration record of past failures matches the failure indicated in the input query 82, and the cause of such failure is clearly indicated in the document. In this case, by correcting the confidence score using the LLM 111, the confidence score of the subKG corresponding to the cause indicated in the document is corrected in a direction where the score increases.

The conversing system 130 corrects the confidence score of any subKG indicated in the confidence score calculation result 83 and sends the confidence score calculation result 85 after confidence score correction in reply to the KG inference unit 120.

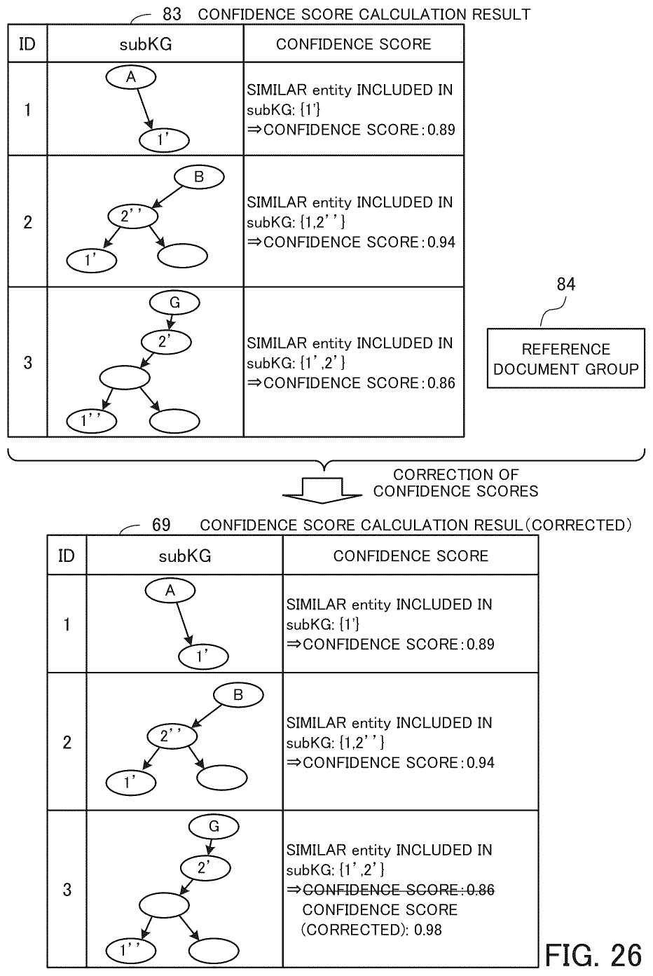

FIG. 26 depicts an example correction result of a confidence score. In the example in FIG. 26, as one example, the confidence score of the subKG with the ID “3” is corrected by comparing the confidence score calculation result 83 with the content of each document included in the reference document group 84 using the LLM 111. As a result, the corrected confidence score calculation result 69 is outputted.

By correcting confidence scores using the LLM 111 in this way, it is possible to generate confidence scores that more accurately reflect the causal relationship between causes and results.

Note that although the KG inference unit 120 sets a predetermined number of entities as the similar entities in descending order of similarity in the second embodiment, entities whose similarity is equal to or greater than a predetermined threshold may be set as the similar entities.

Note also that although the KG inference unit 120 includes failure causes whose confidence score is equal to or greater than a threshold value in the answer in the second embodiment, as another example, a predetermined number of failure causes in descending order of the confidence score may be included in the answer.

According to one aspect, it is possible to improve the estimation accuracy of the cause of a phenomenon.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A cause estimation method comprising:
receiving, by a processor, an input of a sentence indicating a first phenomenon whose cause is to be estimated;
selecting, by the processor, one or a plurality of first nodes indicating a second phenomenon that is similar to the first phenomenon, out of a plurality of nodes in a knowledge graph including the plurality of nodes which indicate a plurality of phenomena and edges indicating causal relationships between the plurality of phenomena;
generating, by the processor, a sub-knowledge graph including a first node and a second node by tracing from the first node as a starting point to the second node at an end on a cause side of the causal relationship indicated by an edge;
determining, by the processor, a confidence level that a third phenomenon indicated by the second node included in the sub-knowledge graph is a cause of the first phenomenon based on a similarity of the first node included in the sub-knowledge graph to the first phenomenon; and
determining, by the processor and based on the confidence level of the sub-knowledge graph, whether to include the third phenomenon indicated by the second node included in the sub-knowledge graph in cause candidates of the first phenomenon.

2. The cause estimation method according to claim 1, further comprising
dividing, by the processor, the sentence into a first sentence indicating a failure and a second sentence indicating a phenomenon caused by the failure,
wherein the selecting of the first nodes includes selecting a node that is similar to the first sentence and a node that is similar to the second sentence as the first nodes.

3. The cause estimation method according to claim 2, wherein the determining of the confidence level includes setting different weightings for the first node that is similar to the first sentence and the first node that is similar to the second sentence, and determining the confidence level based on the similarities of the first nodes and the weightings of the first nodes.

4. The cause estimation method according to claim 1, wherein the determining of the confidence level includes setting weightings in descending order of similarity to the sentence for the first nodes, and determining the confidence level based on the similarities of the first nodes and the weightings of the first nodes.

5. The cause estimation method according to claim 1, wherein the generating of the sub-knowledge graph includes generating the sub-knowledge graph including nodes on a path traced from the first node as a starting point to the second node as an end point and nodes that are reachable by tracing a predetermined causal relationship from a node on the path.

6. The cause estimation method according to claim 1, further comprising outputting, by the processor, the cause candidates arranged in order of the confidence level, the cause candidates being information indicating the third phenomenon determined to be included in the cause candidates.

7. The cause estimation method according to claim 1, further comprising outputting, by the processor, information relating to a phenomenon indicated by each node included in the sub-knowledge graph including the second node corresponding to the third phenomenon determined to be included in the cause candidates, together with information indicating the third phenomenon.

8. The cause estimation method according to claim 1, further comprising correcting, by the processor, the confidence level of the sub-knowledge graph based on information used to generate the knowledge graph using a trained language model.

9. A non-transitory computer-readable storage medium storing therein a computer program that causes a computer to execute a process comprising:
receiving an input of a sentence indicating a first phenomenon whose cause is to be estimated;
selecting one or a plurality of first nodes indicating a second phenomenon that is similar to the first phenomenon, out of a plurality of nodes in a knowledge graph including the plurality of nodes which indicate a plurality of phenomena and edges indicating causal relationships between the plurality of phenomena;
generating a sub-knowledge graph including a first node and a second node by tracing from the first node as a starting point to the second node at an end on a cause side of the causal relationship indicated by an edge;
determining a confidence level that a third phenomenon indicated by the second node included in the sub-knowledge graph is a cause of the first phenomenon based on a similarity of the first node included in the sub-knowledge graph to the first phenomenon; and
determining, based on the confidence level of the sub-knowledge graph, whether to include the third phenomenon indicated by the second node included in the sub-knowledge graph in cause candidates of the first phenomenon.

10. An information processing apparatus comprising:
a memory; and
a processor coupled to the memory and the processor configured to:
receive an input of a sentence indicating a first phenomenon whose cause is to be estimated;
select one or a plurality of first nodes indicating a second phenomenon that is similar to the first phenomenon, out of a plurality of nodes in a knowledge graph including the plurality of nodes which indicate a plurality of phenomena and edges indicating causal relationships between the plurality of phenomena;
generate a sub-knowledge graph including a first node and a second node by tracing from the first node as a starting point to the second node at an end on a cause side of the causal relationship indicated by an edge;
determine a confidence level that a third phenomenon indicated by the second node included in the sub-knowledge graph is a cause of the first phenomenon based on a similarity of the first node included in the sub-knowledge graph to the first phenomenon; and
determine, based on the confidence level of the sub-knowledge graph, whether to include the third phenomenon indicated by the second node included in the sub-knowledge graph in cause candidates of the first phenomenon.
